(19) United States
(12) Patent Application Publication
(10) Pub. No.: US 2023/0011979 A1
(43) Pub. Date: Jan. 12, 2023

(54) HANDHELD DEVICE FOR TRAINING AT LEAST ONE MOVEMENT AND AT LEAST ONE ACTIVITY OF A MACHINE, SYSTEM AND METHOD

(71) Applicant: Wandelbots GmbH, Dresden (DE)

(72) Inventors: Paul Brian Judt, Dresden (DE); Maria Piechnick, Dresden (DE); Christoph-Philipp Schreiber, Dresden (DE); Christian Piechnick, Dresden (DE); Jan Falkenberg, Dresden (DE); Sebastian Werner, Krobeln (DE); Martin Grosser, Heidenau (DE); Georg Puschel, Freital (DE); Klaus Ignaz Wagner, Osann-Monzel (DE)

(21) Appl. No.: 17/757,306

(22) PCT Filed: Dec. 15, 2020
(86) PCT No.: PCT/EP2020/086196

§ 371 Date: Jun. 14, 2022

(30) Foreign Application Priority Data
Dec. 17, 2019 (DE) 20 2019 107 044.7

(51) Int. Cl. B25J 9/16

(52) U.S. Cl. CPC B25J 9/1664; B25J 9/163

(57) ABSTRACT

Disclosed herein is a handheld device for training at least one movement and at least one activity of a machine. The handheld device may include a handle, an input unit configured to input activation information for activating the training of the machine, an output unit configured to output the activation information for activating the training of the machine to a device external to the handheld device, and a coupling structure for releasably coupling an interchangeable attachment configured according to the at least one activity.

### CROSS-REFERENCE TO RELATED APPLICATION(S)

This application is a national phase of PCT/EP2020/086196 filed on Dec. 15, 2020, which claims priority to German Patent Application 20 2019 107 044.7 filed on Dec. 17, 2019, each of which are incorporated in their entirety herein by reference.

### TECHNICAL FIELD

Various embodiments relate to a handheld device for training at least one movement and at least one activity of a machine, a corresponding system, and a corresponding method.

### BACKGROUND

Both the programming of an industrial robot and the programming of the associated system control and/or tooling (also referred to as “tooling”) is conventionally manufacturer- and robot-dependent. Programming is usually done in the form of program code by one or more than one specially trained experts. This is currently still the case for more than 96% of applications. In this case, a programmer manually writes the program code that lets the robot perform the activity autonomously. Therefore, programming is complex and expensive, especially for a path-based or punk-based application (e.g. welding, gluing, painting).

The cost makes automation by means of an industrial robot (simplistically also referred to as a robot) economically unattractive for small and medium-sized companies, as they typically do not maintain high-volume manufacturing with low manufacturing variability that could outweigh the cost. The same is true for other types of robots. For large companies, on the other hand, low programming flexibility may be unattractive. Programming retooling is time-consuming, resulting in shorter and uneconomical production cycles.

The complexity of programming increases due to the integration of the industrial robot with its multiple components, such as an end effector (e.g., a glue gun), a sensor system (e.g., a camera), and a control system (e.g., a programmable logic controller—PLC).

The programming of an industrial robot may alternatively or additionally be carried out by means of CAD-based code generation by the expert. This involves creating a virtual representation of reality (also known as a virtual world) and programming the robot in the virtual world. In addition to simulation, this also allows for easier accessibility. However, this CAD-based code generation cannot be easily implemented by a technical layperson. Furthermore, the virtual world often deviates significantly from reality. Even small deviations may lead to significant discrepancies in the robot's work in reality. For this reason, the program code generated by means of code generation is usually additionally adapted by a programmer.

As an alternative to completely manual programming, a teaching procedure (also referred to as training) is conventionally used.

For the teaching process, the robot may be controlled manually, for example. A sensitive robot (also known as a co-bot) may also be hand-guided, for example. With both mechanisms, the trajectory (i.e., the path along which the robot is to move) may be shown. However, activities beyond the trajectory that the robot is to perform remain complex and are therefore conventionally disregarded by the learning procedure. The complexity consists, for example, in the integration of the multiple components of the robot, such as the end effector, the sensors and the control system, into the process to be executed, which must therefore be programmed manually.

The teaching procedure may alternatively or additionally be performed via an interactive input device. Traditionally, a manufacturer-specific input device, such as a 6d mouse, is used for this purpose. Analogous to manual control or hand-guided control, only the trajectory may be taught in this case as well. The integration of the various components of the robot is therefore performed manually via programming.

The teaching procedure may alternatively or additionally be carried out by means of sensor data processing. For this purpose, various extensions are provided for the end effector of a robot equipped for this purpose, which integrate a sensor system (e.g. a camera) directly into the robot controller. Due to technical limitations, this is so far only applicable for an assembly application (also referred to as pick-and-place applications).

In general, conventionally there is always a share of manual programming. Therefore, these conventional methods have in common that the implementation cannot be done completely by a technical layman if the manual programming part is beyond his capabilities. This is due to the fact that the overall application is an interplay of multiple sub-problems (such as trajectory, end-effector actuation, sensor data processing, and integration with process control). Simple learning methods therefore concentrate on the specification of the trajectory or the recording of path points. The teaching method with sensor data processing is based on sensors directly attached to the robot. However, the field of view is often restricted by the end effector and robot. In addition, changing light conditions or air particles (e.g. during painting) affect the sensors on the robot.

### SUMMARY

According to various embodiments, there are provided a handheld device for training at least one motion and at least one activity of a machine, a corresponding system, and a corresponding method that facilitate automation of a process flow (e.g., one or more than one activity thereof).

According to various embodiments, a handheld device for training at least one movement and at least one activity (also referred to as a process activity) of a machine may include: a handle; an input unit adapted to input activation information for activating the training of the machine; an output unit adapted to output the activation information for activating the training of the machine to a device external to the handheld device; and a (e.g., front) coupling structure for detachably coupling an interchangeable attachment adapted according to the at least one activity.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various non-limiting embodiments are described with reference to the following drawings, in which:

FIG. 1 illustrates a handheld device according to various embodiments in a schematic side view or cross-sectional view;

FIG. 2 shows a system according to different embodiments in various schematic views;

FIG. 3 shows a method according to different embodiments in different schematic views;

FIG. 4 shows a method according to different embodiments in different schematic views;

FIG. 5 illustrates a system according to different embodiments in various schematic views;

FIG. 6 shows a machine according to various embodiments in a schematic diagram;

FIG. 7 shows a system according to different embodiments in various schematic views;

FIG. 8 shows a system according to different embodiments in various schematic views;

FIG. 9 shows a system according to different embodiments in various schematic views;

FIG. 10 shows a handheld device according to various embodiments in a schematic diagram;

FIG. 11 shows a process according to various embodiments in a schematic flow chart;

FIG. 12 depicts a system in a process according to various embodiments in a communication diagram; and

FIG. 13 depicts a trajectory determination mechanism of the system in a schematic communication diagram.

### DESCRIPTION

In the following detailed description, reference is made to the accompanying drawings which form part thereof and in which are shown, for illustrative purposes, specific embodiments. In this regard, directional terminology such as “top”, “bottom”, “front”, “rear”, “frontward”, “rearward”, etc. is used with reference to the orientation of the figure(s) described. Since components of embodiments may be positioned in a number of different orientations, the directional terminology is for illustrative purposes and is not limiting in any way. It is understood that other embodiments may be used and structural or logical changes may be made without departing from the scope of protection. It is understood that the features of the various exemplary embodiments described herein may be combined, unless otherwise specifically indicated. Therefore, the following detailed description is not to be construed in a limiting sense, and the scope of protection is defined by the appended claims.

In the context of this description, the terms “connected”, “connected” as well as “coupled” are used to describe both a direct and an indirect connection (e.g. ohmic and/or electrically conductive, e.g. an electrically conductive connection), a direct or indirect connection as well as a direct or indirect coupling. In the figures, identical or similar elements are given identical reference signs where appropriate.

According to various embodiments, the term “coupled” or “coupling” may be understood in the sense of a (e.g. mechanical, hydrostatic, thermal and/or electrical), e.g. direct or indirect, connection and/or interaction. For example, multiple elements may be coupled together along an interaction chain along which the interaction (e.g., a signal) may be transmitted. For example, two coupled elements may exchange an interaction with each other, such as a mechanical, hydrostatic, thermal, and/or electrical interaction. According to various embodiments, “coupled” may be understood in the sense of a mechanical (e.g., physical or physical) coupling, e.g., by means of direct physical contact. A coupling may be configured to transmit a mechanical interaction (e.g., force, torque, etc.).

For example, a network described herein may have, or be formed from, a local area network (such as a local area network (LAN), a wireless LAN (WLAN), or a personal area network (PAN), such as a wireless PAN (WPAN), such as a Bluetooth network) or a non-local area network (such as a metropolitan area network (MAN), a wide area network (WAN), or a global area network (GAN)), distinguished by range. For example, the network may have, or be formed from, a radio network (such as a cellular network) or a wired network, distinguished by transmission type. For example, the network may also have or be formed from a cellular radio network (e.g., an IEEE 802.11 type WLAN in ad hoc mode, a Bluetooth network, or another cellular mobile network). The network may also have multiple interconnected sub-networks of different types.

The transmission of information (information transmission) may be performed according to various embodiments according to a communication protocol (KP). The information transmission may include generating and/or transmitting a message including the information according to the communication protocol. The communication protocol may illustratively denote an agreement according to which the information transfer proceeds between two or more parties. In its simplest form, the communication protocol may be defined as a set of rules that specify the syntax, semantics, and synchronization of information transmission. The communication protocol or protocols used (e.g., one or more network protocols) may be chosen in principle at will and may (but need not) be configured according to the OSI (Open System Interconnect) reference model. Any protocols may also be used in the respective protocol layers. For example, the protocols according to Bluetooth or other radio-based communication protocols may be used. Thus, transmitting information using Bluetooth herein may include generating and/or transmitting a message including the information according to a Bluetooth communication protocol stack. The Bluetooth communication protocol stack may optionally be established according to a low-energy communication protocol stack, i.e., the information may be transmitted via low-energy Bluetooth.

Various steps and details concerning a method are described below. It may be understood that what is described (e.g., individual steps of the method) may be implemented by analogy using hardware (such as a hardwired circuit) and/or software (e.g., code segments or an entire application). For example, an application (also referred to as a program) may be or may be provided including corresponding code segments (e.g., program code), and may be or may be executed on a processor and/or by means of a circuit including the processor. For example, the processor (or the circuit) may be part of a mobile device or a computing device. The computing device may, for example, include a plurality of processors centrally located within a physically contiguous network or may be decentrally interconnected by means of a (for example, cellular or wired) network. In the same way, code segments or the application may be executed on the same processor, or parts thereof may be distributed among a plurality of processors that communicate with each other by means of the (for example, cellular or wired) network.

The term “processor” may be understood as any type of entity that allows processing of data or signals. For example, the data or signals may be handled according to at least one (i.e., one or more than one) specific function performed by the processor. A processor may include or be formed from an analog circuit, a digital circuit, a mixed signal circuit, a logic circuit, a microprocessor, a central processing unit (CPU), a graphics processing unit (GPU), a digital signal processor (DSP), a programmable gate array (FPGA), an integrated circuit, or any combination thereof. Any other type of implementation of the respective functions, described in more detail below, may also be understood as a processor or logic circuit, for example including virtual processors (or a virtual machine) or a plurality of decentralized processors interconnected, for example, by means of a network, distributed arbitrarily spatially and/or having arbitrary shares in the implementation of the respective functions (e.g., computational load sharing among the processors). The same generally applies to differently implemented logic for implementing the respective functions. It is understood that one or more of the method steps described in detail herein may be executed (e.g., implemented) by a processor, by one or more specific functions executed by the processor.

The term “system” may be understood as a set of interacting entities. The set of interacting entities may, for example, include or be formed from at least one mechanical component, at least one electromechanical transducer (or other types of actuators), at least one electrical component, at least one instruction (e.g., encoded in a storage medium), and/or at least one control device. Multiple communicatively connected entities of the system may be managed, for example, using a common system management system of the system. For example, the entities (e.g., the handheld device and/or a device external to the handheld device) of the system may be or may be registered in the system, e.g., by means of the system management.

The term “actuator” (also referred to as actuator or actuator) may be understood as a component that is set up to influence a mechanism or a process in response to actuation. The actuator may convert instructions issued by the control device (called actuation) into mechanical movements or changes in physical variables such as pressure or temperature. For example, the actuator, e.g. an electromechanical converter, may be set up to convert electrical energy into mechanical energy (e.g. by movement) in response to a command.

The term “control device” may be understood as any type of logic-implementing entity that may, for example, include circuitry and/or a processor that may execute software stored in a storage medium, in firmware, or in a combination thereof, and issue instructions based thereon. For example, the control device may be configured using code segments (e.g., software) to control the operation of a system (e.g., its operating point), e.g., a machine or a system, e.g., at least its kinematic chain. The operating point may describe the point in the characteristic diagram or on the characteristic curve of a technical device, which is taken due to the system properties and acting external influences and parameters of the device. The operating point may illustratively describe the operating state (i.e. actual state) of the device. The working point must be distinguished from the working location (i.e. the spatial location where, for example, the effect by the machine occurs).

Control may be understood as an intended influencing of a system. The state of the system may be changed according to a specification using an actuator. Control may be understood as controlling, where additionally a change of state of the system is counteracted by disturbances. Illustratively, the control system may have a forward control path and thus illustratively implement a sequential control system that converts an input variable into an output variable. However, the control path may also be part of a control loop, thus implementing closed-loop control. In contrast to the pure forward sequential control, the closed-loop control has a continuous influence of the output variable on the input variable, which is caused by the closed-loop control (feedback).

A process activity (also simply referred to as an activity) may be understood as the sum of all operations (e.g. a temporal sequence of controlled events) which fulfill a predefined process task. The process activity may optionally be decomposed into subprocesses, each of which considers at least one of the operations. A subprocess of the process activity may perform a subtask (i.e., part of the process task) or the entire process task. Several subprocesses may, depending on the nature of the process activity, be interrelated and/or build on each other, e.g., be in a strict sequence, and/or be independent of each other, e.g., be interchangeable.

Illustratively, for each of the subprocesses an operation (e.g. a grinding operation) and a location of the operation may be considered, which together describe the subprocess. Thus, it may be considered which action is to be performed at which location of the workpiece (the so-called work location), e.g. where the workpiece is to be machined and in which way. To fulfill the process task, a movement of the machine may take place, for example by means of adjusting the kinematic chain of the machine and/or moving the machine. Smaller movements of the machine may also be made, for example, in which the position of the end effector and/or the robot arm itself remain stationary and only the tool of the machine is moved. For example, a drill bit as a tool of the machine may track the progressive removal of material at the work location so that the drill bit of the machine is moved into the drill hole.

At least one vector of the operation (e.g. of a grinding operation) may be assigned to a subprocess for this purpose. The same may apply analogously for a plurality of subprocesses or several operations per subprocess. A vector may generally be understood as an element of a vector space, which does not necessarily have to be only spatial or only three-dimensional. The vector may generally have associated parameters of a parameter set of the process activity, e.g., process parameters, location parameters, or input data. However, the parameters of the parameter set may also be formulated differently than by means of a vector. More generally, what is described for the vector (or its components) may apply by analogy to a more generally formulated parameter set.

The vector may define at least one position, its change, a spatial distribution, and/or at least one direction of the process. The spatial information (e.g., about the process activity) described herein in a simplified manner by means of a vector may also be more complex or detailed and is referred to herein more generally as spatial information. Optionally, the spatial information may be associated with temporal information (e.g., about the process activity) that defines, for example, the duration, start, completion, and/or a timing of the process. In a simple example, the temporal information may also only order the processes chronologically, insofar as this is desired.

If the process activity is performed by a hand-held tool, the process activity may describe the sum of operations, the spatial information may describe the spatial sequence of operations, and the optional temporal information may describe the chronology of operations performed by the tool to provide the corresponding effect on a workpiece to achieve the process task. The corresponding spatial information may describe where (i.e. with which spatial distribution) and/or with which direction the effect is to be provided, i.e. in which corresponding spatial position (i.e. position and/or orientation) the working device is located for this purpose.

This process activity information (also referred to as process information), i.e., the type of activity, the spatial information, and the optional temporal information, may also be provided and/or recorded by means of the handheld device described herein. For this purpose, an interchangeable attachment is coupled to the handheld device, which is set up according to the type of activity. The handheld device may be hand-guided (i.e., manually guided by a person) in a manner analogous to the tool, as if the work process were actually taking place by means of the interchangeable attachment. In contrast to the tool, however, the hand-held device is equipped with electrical components (e.g. sensors, interfaces, transmitters, etc.) that enable the process information to be recorded and made available as training data. In this regard, the handling of the handheld device may reflect the manner in which the tool is guided and/or actuated when performing a process sequence, e.g., how it is held, how hard it is pressed, and/or how long a work process is performed. The training data may be recorded, for example, using a local computing system or delocalized (e.g., in a cloud).

A model may be understood as a data-based (e.g. digital and/or virtual) representation of an original, e.g. a physical object (e.g. a machine) or an operation (e.g. a control operation or a process flow). To form the model (called model building, i.e., mapping the original to the model), the original may be abstracted, parameterized, and/or simplified. For example, the model may include physical information (e.g., length, distance, weight, volume, composition, etc.), movement-related information (e.g., position, orientation, direction of movement, acceleration, speed of movement, etc.), logical information (links, order, couplings, interrelationships, dependencies, etc.), time-related information (e.g. time, total duration, frequency, period duration, etc.) and/or functional information (e.g. current intensity, effect, characteristic field or characteristic curve, operating location/space, force, degree of freedom, etc.) about the original.

Accordingly, a control model may denote a formal representation of an automated control. The control model may have a plurality of instructions for control (e.g., to bring the machine to a working point), and further may have criteria whose fulfillment triggers, terminates, or maintains the instruction associated therewith. Further, the control model may have control logic that logically links a plurality of criteria and/or a plurality of instructions, and/or that implements a sequence (e.g., a flowchart) according to which actuation occurs. From the path to the control model, a machine type-specific model representing a machine type (i.e., a type of identical machines) may optionally be ascertained as an intermediate step. When mapping the machine type-specific model to the control model, type-specific deviations of the machines of one type from each other may be taken into account (also referred to as delta mapping).

In an analogous way, a process model may denote a formal representation of a process flow. The process model may have a large number of links between a process activity and the corresponding spatial information and optionally assign corresponding process situations to the process activities, which, for example, are present at the process activity, condition it or terminate it. Furthermore, the process model may have a process logic which logically links several process situations and/or several subprocesses, and/or which implements a flow (e.g., a flowchart) according to which the process activity takes place. In general, a flowchart may have at least branches, jumps and/or loops. The presence or absence of a process situation may generally be represented by means of at least one criterion which is fulfilled, for example, when the process situation is present or absent.

A mapping may involve the transformation of elements of a source set (also called an original image) into a target set, where the elements of the target set are then the image (mapping) of the original image. Mapping may associate at least one element of the mapping with each element of the primal image. The primal image need not necessarily have all available elements, but may be an application-specific selection thereof. The mapping may have, for example, operators, transformations, and/or links applied to the elements of the initial set. In general, the elements may have: logical relations, links, information, properties, coordinates or the associated coordinate system, mathematical objects (such as formulas or numbers), processes, activities, etc.

A code generator may be understood as a computer program which is set up to convert a model, e.g. in a modeling language, into a programming language, e.g. the programming language of the control device of the machine. Alternatively or in addition to the modeling language, e.g., a unified modeling language (UML), the model may also be present in a markup language, a structure chart, a decision table, or another formal language. The code generator creates code segments (also referred to as code generation) that may be combined with other optional program parts to form a program.

As used herein, spatial position may be understood as spatial information about an orientation and/or position of an object. The position may illustratively describe the location (e.g., a point) in space and the orientation may illustratively describe the respective orientation (e.g., a direction) of an object relative to the space. A trajectory may be understood as a sequence of spatial positions taken successively by an object. The spatial position may optionally be time-dependent (i.e., motion-related, then also referred to as motion), according to a clock rate or velocity, such that motion along the trajectory is considered. By analogy, the motion may optionally be time-dependent, such that acceleration along the trajectory is accounted for. In general, spatial location or other spatial information in three-dimensional space may be described using Cartesian coordinates. However, any other coordinate system may also be used, e.g. cylindrical coordinates or also the so-called Jointspace (also referred to as machine-specific coordinate system), which is suitable for unambiguously describing the spatial information. The machine-specific coordinate system may be related to the kinematic chain of the machine and have one dimension for each degree of freedom of the kinematic chain. This makes it possible to represent not only the position of the end effector in space but, in addition, the state of each link (e.g., joint or other link) of the kinematic chain, allowing more precise control of the machine. Illustratively, the machine-specific coordinate system may have a plurality of nested coordinate systems, each of the nested coordinate systems taking into account the degrees of freedom (e.g., up to 6 degrees of freedom, including up to 3 rotational degrees of freedom and/or up to 3 translational degrees of freedom) of a link of the kinematic chain.

According to various embodiments, there are provided a handheld device (for training at least one movement and at least one activity) of a machine, a corresponding system, and a corresponding method that facilitate the teaching (also referred to as training) of a machine. For example, generation of a fully integrated program code may be provided that, when executed by a processor of the machine, is configured to autonomously execute the activity by means of the machine. For example, the training (up to the generation of the program code) may be particularly fast, e.g., by demonstrating the activity manually (i.e., by a person) using the handheld device. For example, it is possible to switch between different activities in an uncomplicated and quick manner, e.g. by changing the interchangeable attachment coupled to the handheld device or by changing between the tools of an interchangeable attachment. For example, different types of machines may be taught using the same system, e.g. by ascertaining a platform-independent process model as an intermediate step. For example, teaching may be particularly cost-saving, e.g., because fewer programmers are needed to create the program code. For example, different interchangeable attachments may be assigned to the same activity. However, several activities may also be assigned to exactly one interchangeable attachment.

According to various embodiments, the handheld device may allow recording of data representing the movement and/or the at least one activity of the machine freely in space, e.g., without a fixed point (e.g., physical or virtual) and/or bearing axes. For example, the handheld device may be free to move in space so as to perform the activity to be taught, for example on a workpiece. This may be achieved, for example, by the handheld device being free of mounting (i.e. bearing) on one or more than one physical axis.

This makes it possible to increase the training space in which the handheld device may be moved for training, so that, for example, little or no restriction of the training space (at least by the handheld device itself) remains. For example, the handheld device may be handled by a person overhead, lying down or in other positions (e.g. only one-handed or two-handed). This facilitates, for example, its handling in obstructed work spaces.

For example, the handheld device may be moved independently of the machine, e.g., be free of coupling with the machine (e.g., not be coupled with the machine). A communicative coupling between the machine and the handheld device may optionally be present, e.g., by means of a replaceable cable or wirelessly. Alternatively or additionally, the handheld device may be free of an articulated coupling or other bearing that is coupled to the machine, for example.

The recording of data representing the movement and/or the at least one activity of the machine may be done, for example, in a coordinate system that is independent of the machine that is to be trained, for example. For example, the handheld device and/or its movement and/or the recording of data may be independent of the machine its workspace, its reference point or machine coordinate system, and/or its base). The reference point (also referred to as Tool Center Point, TCP) may, for example, be a fixed coordinate in the machine coordinate system.

By means of the system, trajectories with any number of waypoints may be determined. For each waypoint, one or more than one of the following properties may be or become parameterized: a type of motion (point-to-point, linear, circular, and polynomial), the trajectory, a velocity or its change (i.e., acceleration), a force (e.g., its moment, i.e., a torque), one or more than one pieces of information about the tool, and/or an overgrinding radius. Alternatively or additionally, for each waypoint, one or more than one of the following may be or become parameterized: a state of the function of the interchangeable attachment, and/or sensor data (e.g., of the interchangeable attachment and/or the handheld device).

For example, the trajectory may be or become piecewise composed of polynomials. For example, the resulting polynomial train may consist of polynomials of at most nth degree, providing an nth degree polynomial train (also referred to as an nth degree spline). The points of the trajectory where two polynomials are adjacent (the so-called knots) may optionally be (n−1)-times continuously differentiable. For example, the polynomial train may be used to convert a point-based trajectory (whose points define the knots) into a path-based trajectory by searching polynomials that connect the points of the point-based trajectory.

Different tool and/or workpiece coordinate systems may be configured. The trajectory may be described, for example, by specifying the successive path points (then also referred to as point-based trajectory), by specifying the traversed path curve (then also referred to as path-based trajectory) or by a mixture of these specifications.

The point-based trajectory may, for example, leave open the way in which the waypoints are taken one after the other, i.e. it may leave the determination of the concrete path curve connecting the waypoints to the control device or the possibilities of the machine. The point-based trajectory is suitable, for example, if the activity has discrete work steps at discrete locations (for example, pick-and-place).

The path-based trajectory enables a one-to-one waypoint-time assignment and thus describes in detail which waypoint is taken at which point in time. The path-based trajectory is suitable, for example, if the activity is to take place along a specific path or at a specific speed (for example, spreading glue or painting).

According to various embodiments, training of the machine is performed using the training data. For this purpose, the training data may be recorded. For example, the recording of the training data may be started by entering the activation information. In principle, however, the recording of data may also take place before the actual training, for example as soon as the handheld device is switched on and/or registered in the system. In that case, the activation information may indicate which part of the recorded data is used as training data. In other words, of the recorded data, those that are used as training data may be filtered out by means of the activation information (e.g., time-resolved). For this purpose, the activation information may have, for example, a timestamp that is matched with the time-resolved recording of the data. Alternatively, the filtering of the recorded data may be performed after the recording has stopped, e.g., manually using a graphical representation of the recorded data. In that case, those data may be marked by the user by means of the activation information which are to be fed as training data to the training of the machine (e.g. a beginning and an end of a data sequence). In an analogous way, additional data may be added to the already existing training data or parts may be removed from the already existing training data. Filtering may be done, for example, by means of a device external to the handheld device.

Filtering out the training data (also referred to as filtering for short) may include, for example, playing back the entire recorded motion sequence using the device external to the handheld device and examining its movements. Playback of the recorded motion sequence may be performed using the physical robot and/or using a virtual representation of the robot. For example, the recorded data may be played back once or more than once on the robot by means of a remote access (e.g., an application program, such as an iOS application) and the movements may be examined. Individual points in space, so-called keyframes, which are to be retained as training data, may thereby be marked in the data and fine-tuned if necessary, e.g., using functions in the various coordinate systems. Additionally or alternatively, machine learning and mathematical optimizations may be used to predict and filter markable points and/or all or parts of the entire data used for training. Filtering may include, for example, taking into account anomalies, motion quality and expression strength, redundant information, and/or data reduction.

Additionally or alternatively, the robot's travel mode (also referred to as motion mode) between two points may be defined, for example, point-to-point, linear, or semi-circular travel mode. Filtering may be repeated one or more times using information specified by the user, for example until the data to be used for training is ascertained.

The sum of all marked points (keyframes) of the recorded motion sequence and its traverse mode may be used as training data or at least as part of it. Optionally, the marked points may be shifted in a Cartesian manner in space and/or the end effector of the robot may be rotated around such a point.

Examples of filtering or components of filtering may thus include: Detecting and removing anomalies from the training data, smoothing the training data (e.g., to improve motion quality and its expressiveness), detecting and removing redundant parts of the training data (e.g., those that are identical or at least provide little added value), data reduction while preserving content.

Alternatively or in addition to filtering, parts of the training data may be grouped, e.g. as a representation of individual operations or activities of the more complex overall process.

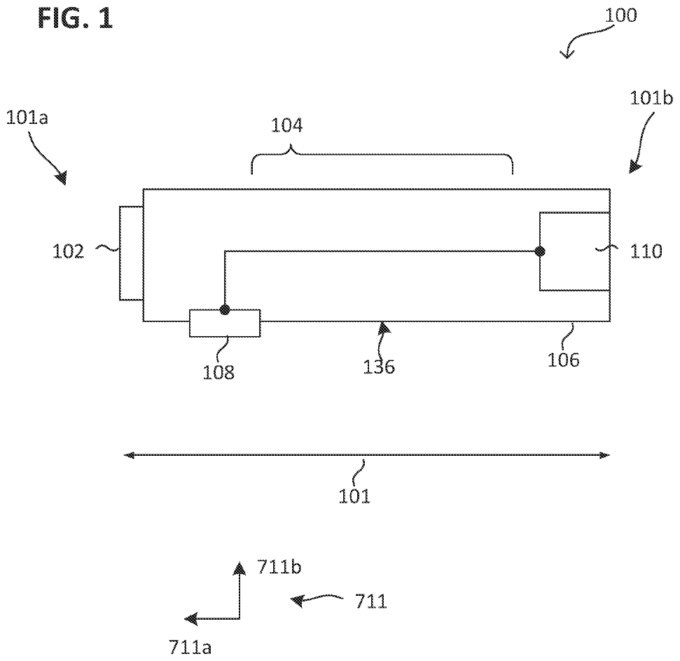

FIG. 1 illustrates a handheld device 100 according to various embodiments in a schematic side view or cross-sectional view. The handheld device 100 may have a longitudinal extent 101 (extent in the longitudinal direction 711a) that is, for example, in a range from about 10 cm (centimeters) to about 50 cm, for example, in a range from about 15 cm to about 30 cm. Along the longitudinal direction 711a, the handheld device 100 may be bounded by two end faces 101a, 101b, a first end face 101a of which includes the coupling structure 102. The coupling structure 102 (e.g., a coupling mechanism) may be configured for releasably coupling an interchangeable attachment, as will be described in more detail later.

The handle 104 may extend away from the coupling structure 102 along the longitudinal direction 711a. For example, the handle 104 may be ergonomically shaped, such as rounded, tapered, and/or otherwise conformed to the shape of a hand. In general, the handle 104 may be adapted to be grasped and/or held by one or more than one hand of a user. For example, various embodiments do not necessarily need to include a separate handle (extra handle), but may have such handle integrated. To this end, for example, the handle 104 may have a longitudinal extension 101 that is, for example, in a range of about 5 cm (centimeters) to about 30 cm, for example, in a range of about 10 cm to about 20 cm. Alternatively or additionally, the handle 104 may have a perimeter (e.g., along a self-contained path that is transverse to the longitudinal direction 711a) that is in a range from about 10 cm to about 30 cm.

The handle 104 may also be oriented differently relative to the coupling structure 102, for example extending obliquely to the coupling direction so that the handheld device 100 is angled. This may be more intuitive for some activities. Of course, what is described herein for the elongated handheld device 100 may apply by analogy to a different configuration or orientation of the handle 104. Similarly, the handheld device 100 may have multiple handles (e.g., extending away from or transversely to each other) that enabled safe handling of the handheld device 100. By analogy, the or each handle may have multiple grip points for multiple hands. One or more than one of the handles may be the handle of the handheld device. One or more than one of the handles may be or may be removably attached to the handheld device, for example as a component of the interchangeable attachment or provided as a separate handle. One or more than one of the handles of the handheld device may be persistent (permanent) or non-persistent.

Optionally, the handheld device 100 may include one or more than one user interface (e.g., user input interface and/or user output interface). Examples of the one or more than one user interface of the handheld device 100 may include a screen (also referred to as a display device), a physical keyboard, a speaker, a vibration device, one or more than one physical switch (e.g., push button), one or more than one light source, or the like. Alternatively or additionally, the handheld device 100 may include one or more than one sensor, as will be described in more detail later. The vibration device may generally include a vibration exciter, such as a diaphragm or piezoelectric element. The vibration exciter may be configured to convert an electrical signal coupled thereto into a mechanical vibration that is haptically detectable (also referred to as a vibration) (e.g., having the frequency of the signal).

The input unit 108 may be provided, for example, by means of a user interface (then also referred to as a user input interface) configured to be actuated by a user, such that the activation information may be input by means of actuating the user interface. The activation information may generally be captured by means of a sensor, such as a touch-sensitive sensor (which provides a touch-sensitive input unit 108). Alternatively or additionally, the input unit may include another sensor that may capture an activation of the input unit. For example, the sensor of the input unit 108 may be a proximity sensor, a touch sensor, a physical switch (e.g., push button), or the like.

For example, the input unit 108 may be part of or adjacent to the handle 104. This facilitates the operation.

The activation information may generally trigger the activation of the training of the machine. In a less complex example, training may be activated when a user input (e.g., including a force and/or a touch) is captured by the input unit 108. For example, the switch may be actuated by means of the force, thereby activating the training. Similarly, training may be disabled, for example, when it is captured that another user input is occurring or the user input is interrupted. However, more complex user inputs may be implemented. For example, a first input sequence (for example, a long or repeated key press) may enable training and/or a second input sequence may disable training. For example, the input unit 108 enables recording of information about the activity to start and/or stop. However, the functions provided by means of the input unit 108 may also be provided, in whole or in part, by means of another device external to the handheld device, for example, by means of a wireless switch and/or by means of a mobile computing device (for example, a tablet) on which, for example, an application emulating the functions of the input unit 108 is executed.

More generally, a first activation information entered by means of the input unit 108 may represent that the training is to be activated and/or continued. Alternatively or additionally, a second activation information entered by means of the input unit may represent that the training is to be deactivated and/or interrupted.

The input unit 108 may optionally be set up according to a near-field communication protocol according to which the activation information is input. For example, NFC may be used to input the activation information.

The activation information may be output (e.g., communicated) by means of the output unit 110. For example, the output unit 110 may be configured to output the activation information according to a communication protocol, such as according to a network communication protocol. For example, the activation information may be transmitted by wire (also referred to as wired) or wirelessly. In principle, any communication protocols may be used, standardized or proprietary communication protocols. In the following, reference is made to wireless communication of the output unit 110 (e.g., using radio) for ease of understanding. However, what is described may also apply by analogy to a wired communication of the output unit 110.

For example, the output unit 110 may include a data transmission interface, such as a signal generator and an antenna. The signal generator may, for example, be configured to encode the activation information, e.g. according to the communication protocol, and to supply a signal according to the encoded activation information to the antenna.

For example, the handle 104, the input unit 108, and/or the coupling structure 102 may be part of a housing 136 of the handheld device 100 or may be supported by the housing 136. The housing 136 may include a hollow body in which one or more than one electrical component of the handheld device 100 is disposed, such as the output unit 110, at least one sensor, a battery, etc.

To make the handheld device 100 easier to handle (e.g., move), the handheld device 100 may be lightweight, e.g., have a weight of less than about 5 kg (kilograms), e.g., than about 2.5 kg, e.g., than about 1 kg, e.g., than about 0.5 kg. Alternatively or additionally, the handheld device 100 may be made of a lightweight material. For example, a housing 136 of the handheld device 100 may include or be formed from a plastic and/or light metal.

In general, the coupling structure 102 does not necessarily need to be disposed frontally. For example, the coupling structure 102 may also be disposed at any position of the end portion of the handheld device 100 that extends away from the handle 104, such as laterally. A front coupling structure 102 may be more intuitive and easier to use. A side coupling structure 102 may allow for more complex coupling mechanics. For example, multiple magnets may be disposed along an annular path on the outside of the end portion.

In the following, reference will be made to a front coupling structure 102 for ease of understanding. What is described may apply by analogy to a differently arranged coupling structure 102, such as a laterally arranged coupling structure 102.

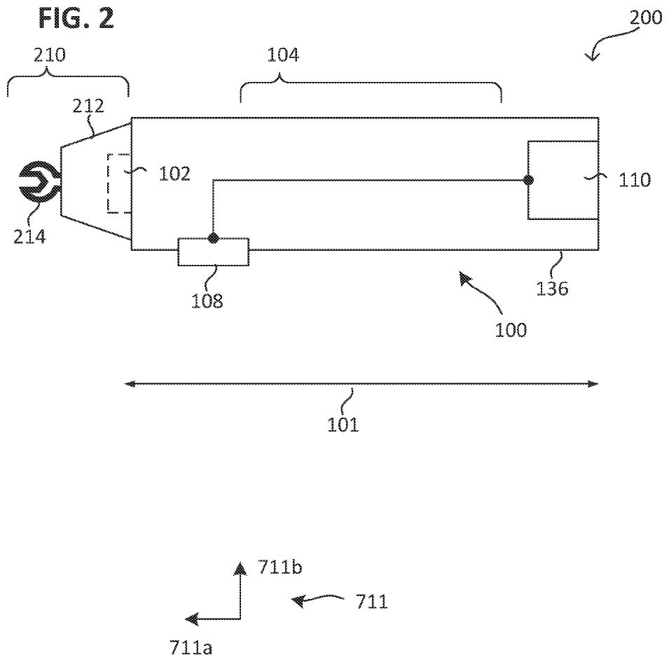

FIG. 2 illustrates a system 200 according to various embodiments in a schematic side view or cross-sectional view, wherein the system 200 includes the handheld device 100 and an interchangeable attachment 210 that is releasably coupled to the coupling structure 102.

Detachable coupling may be understood as allowing the interchangeable attachment to be non-destructively attached to and/or detached from the handheld device 200 by means of the coupling structure 102, for example repeatedly and/or without requiring tools. For example, two interchangeable attachments may be interchangeable with each other.

To this end, the coupling structure 102 and the or each interchangeable attachment 210 may be configured to correspond to each other so that, when brought into physical contact with each other, they may be connected to each other, for example by means of relative movement of them with respect to each other. In an analogous manner, they may be separated from each other again, so that the interchangeable attachment 210 may be spaced apart from the coupling structure 102 or replaced.

For example, the or each interchangeable attachment 210 may include a mating coupling structure 212 corresponding to the coupling structure 102 that may be connected together. For example, the connection may be by means of a form fit and/or a force fit. If the coupling structure 102 exhibits a bayonet or thread, this may provide a positive connection. If the coupling structure 102 has a male portion, this may provide a force fit by means of mating. Such a connection is inexpensive to implement and easy to handle.

For example, the coupling may be accomplished using a magnetic field, such as by having the coupling structure 102 and/or the interchangeable attachment 210 include a magnet that provides the magnetic field. The magnet may be a permanent magnet or an electromagnet. The magnetic field may provide an attractive force between the coupling structure 102 and the interchangeable attachment 210, for example by means of a ferromagnetic material of the interchangeable attachment 210.

The interchangeable attachment 210 may be set up according to the activity to be trained. For example, the interchangeable attachment 210 may include a tool 214 for performing the activity. The tool 214 may generally represent a function corresponding to the activity by means of which a workpiece is acted upon. For example, the tool 214 may represent a forming tool, inspecting tool, a joining tool (e.g., screwdriver, glue gun, or welder), a displacement tool (e.g., gripper), a cutting tool, or the like. For example, the joining tool may include or be formed from a coating tool (e.g., a paint gun, a powder coating gun). However, the tool 214 of the interchangeable attachment 210 need not or need not be fully functional, but it may be sufficient if the tool 214 of the interchangeable attachment 210 has the shape and/or contour of the real process tool and/or at least an image thereof (for example, analogous to a dummy element).

For example, the system 200 may include multiple (e.g., at least 2, 3, 4, 5, 10, or at least 20) such interchangeable attachments 210 that differ from one another in their tooling 214. Of the plurality of interchangeable attachments 210, one interchangeable attachment may be or may be coupled to the handheld device 100. If the tool is to be changed, a first interchangeable attachment 210 coupled to the handheld device and having a first tool 214 may be exchanged for a second interchangeable attachment having a second tool 214 different therefrom.

The system 200 may have other components, as will be described in more detail later.

The pair of handheld device 100 and interchangeable attachment 210 coupled thereto is also referred to hereinafter as training device 302, and the tool of interchangeable attachment 210 is referred to as training tool 214. In general, an interchangeable attachment 210 may also have multiple training tools 214 that differ, for example, in the activity according to which they are set up. For example, the multiple training tools 214 of the interchangeable attachment 210 may be rotatably mounted to the mating coupling structure 212.

For example, an electrical power of the or each training tool 214 may be less than that of the handheld device 100, making it easier to electrically power the training tool 214 using the handheld device 100 and/or enabling a passive training tool 214.

For example, in various embodiments, the training tool 214 may be or may be provided as a non-fully functional tool.

For example, a weight of the or each training tool 214 may be less than that of the handheld device 100, making it easier to carry the training tool 214 using the handheld device 100 and simplifying its attachment.

For example, a material of the or each training tool 214 may be plastic and/or light metal (e.g., aluminum). This reduces its weight.

For example, a size (e.g., volume and/or extent along the longitudinal direction) of the or each training tool 214 may be smaller than the handheld device 100, making it easier to carry the training tool 214 using the handheld device 100 and simplifying its attachment. If less or no facilitation may be accommodated, the training tool 214 may be the same size or larger than the handheld device 100.

The coupling structure 102 may facilitate replacement of the interchangeable attachment 210, as described in more detail below. Alternatively to the coupling structure 102, the training tool 214 may be fixedly (i.e., non-detachably) attached to the handheld device 100 (such that it cannot be non-destructively changed without tools, i.e., without assembly). For example, the training tool 214 may be otherwise attached to the face by means of screws, e.g., welded or bonded thereto. For example, the training tool 214 may be embedded in the end face. Such a handheld device 100 with a fixedly installed training tool 214 may then be configured for training exactly the one activity according to which the training tool 214 is configured. What is described below for the handheld device 200 with coupling structure 102 may apply analogously to the handheld device with permanently installed training tool 214. In various embodiments, the activity general may be defined by the process task it is to perform, rather than (e.g., only) by the specific operation to perform the process task. This allows, for example, variations in performing the same process task to be considered, and thus more freedom in designing the training of the machine. For example, the activity may include variations or variations of operations, as well as similar or like operations that perform the same process task.

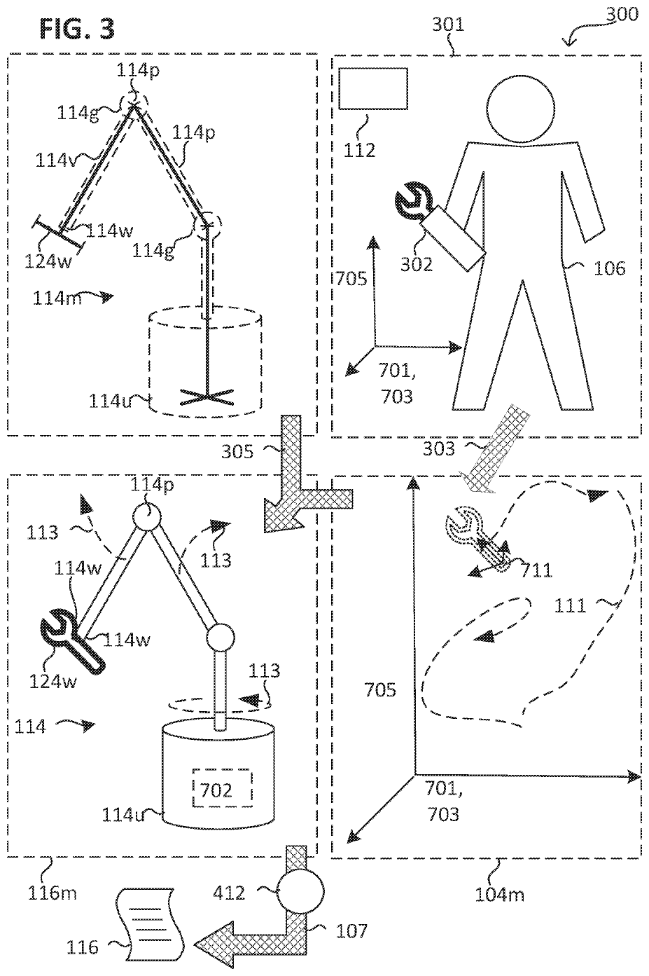

FIG. 3 illustrates a method 300 according to various embodiments in various schematic views.

Further shown in FIG. 3 is a machine 114 to be trained. The machine 114 to be programmed may be a robot, e.g., an industrial robot, for handling, assembling, or processing a workpiece, a collaborative robot (also referred to as a cobot), or a service robot (e.g., a cooking machine or a grooming machine). For example, the method 300 enables end-user programming of the complete automation application (including process parameters and integration) by a technical layperson. The machine 114 to be trained may be a physical machine. By analogy, what is described for the same herein may also apply to a virtual machine 114 to be trained.

For example, when using multiple physical machines 114 of the same type (for example, by averaging the manufacturing inaccuracies of each of the machines), an idealized virtual model of the type (the machine type-specific model) may be used, which is trained. Based on the trained virtual machine 114, the control information may be ascertained (illustratively a mapping of the physical machine), e.g., in an automated manner.

The machine 114 to be trained may generally include a manipulator and a frame 114u on which the manipulator is supported. The term manipulator subsumes the set of movable members 114v, 114g, 114w of the machine 114, the actuation of which enables physical interaction with the environment, for example, to perform a process activity. For actuation, the machine 114 may include a control device 702 (also referred to as machine control 702), which is configured to implement the interaction with the environment according to a control program. The last member 114w of the manipulator (also referred to as the end effector 114w) may include one or more than one tool 124w (also referred to as the process tool 124w) that is configured in accordance with the activity to be trained, for example, to perform the activity. The process tool 124w may include, for example, a welding torch, a gripping instrument, a glue gun, a painting device, or the like.

The manipulator may include at least one positioning device 114p, such as a robotic arm 114p (more commonly referred to as an articulated arm), to which the end effector 114w is attached. Illustratively, the robotic arm 114p provides a mechanical arm that may provide functions similar to or even beyond a human arm (e.g., multi-axis motion per joint or combined rotation and pivoting per joint). For example, the robotic arm 114p may have multiple (e.g., at least 2, 3, 4, 5, 10, or at least 20) joints, each joint of which may provide at least one (e.g., 2, 3, 4, 5, or 6) degrees of freedom.

The manipulator may of course be set up differently, for example in a gantry machine, the general type of multi-joint robots or a delta robot. For example, the machine may have an open kinematic chain or a closed kinematic chain. In the following, reference will be made to the more easily understood robot arm 114p. By analogy, what is described for the robotic arm 114p may also apply to a differently configured machine or manipulator.

The members of the positioning device 114p may be, for example, link members 114v and joint members 114g, wherein the link members 114v are interconnected by means of the joint members 114g. An articulation member 114g may include, for example, one or more joints, each of which may provide rotational motion (i.e., rotational movement) and/or translational motion (i.e., translation) to the interconnected connection members 114v relative to one another. The movement of the link members 114g may be initiated by actuators controlled by the control device 702. One or more than one joint may also include or be formed from a ball and socket joint.

In 301, a training device 302 (including the handheld device 100 and interchangeable attachment 210 coupled thereto) may be or may be provided. To train (for example, once or while training is enabled), a person 106 (also referred to as a user) may perform an activity to complete the process task using the training device 302 (e.g., painting, fabricating, and/or assembling a component). For example, the training tool 214 may represent any process tool 124w that may guide a machine 114. To this end, the process tool 124w may interact with the workpiece.

For training, the training device 302 may transmit data to a device external to the handheld device, such as at least the training data. The training data may include or be formed from the activation information and optionally spatial information. Optionally, the training data may have one or more of the following information: One or more calibration values, quality information, sensor data, (e.g. aggregated, fused and/or optimized) information, activation information. For example, quality information may indicate a reliability of a training data point, such as illustratively how good the data point is. The quality information may be or may be associated with each data point of the training, e.g., by means of the device external to the handheld device. For example, the activation information may be related to the end effector of the machine, e.g., its gripper system and/or welder.

For example, the spatial information may represent a location and/or change thereof (i.e., movement) of the training device 302 in space. The activation information may represent an input to the input unit 108. The motion may include, for example, translation and/or rotation of the training device 302 and may be ascertained, for example, by measuring acceleration and/or velocity.

For example, the device external to the handheld device receives the time-dependent location 111 (i.e., location and/or orientation) of the training tool 302 or its coordinate system 711 in space 701, 703, 705 (e.g., within a building 511). Based on this, the time-dependent position 111 of the training tool 214 may be ascertained. A plurality of positions that an object (e.g., the handheld device 100, its coordinate system 711, and/or the training tool 210) may occupy may be represented using a trajectory 111 (also referred to as a training trajectory). Each point of the trajectory 111 may optionally be associated with a time and/or an orientation of the object. Each point of the trajectory 111 and/or orientation may be specified using corresponding coordinates. In an analogous manner, the trajectory 111 may alternatively or additionally be referenced to the coordinate system of the handheld device 100 and/or to a work location. The space 701, 703, 705 (also referred to as the workspace) in which the trajectory 111 is specified may be spanned by a coordinate system that is stationary, i.e., has an invariant position with respect to the earth's surface.

Each point (e.g., vector) of trajectory 111 may optionally have associated therewith one or more than one activity-specific and/or tool-specific process parameter, e.g., a flow rate, a flow rate, an intensity, an electrical output, a keystroke, etc.

To this end, for example, a locating device 112 may be stationary and may define (e.g., span) the coordinate system 711. The locating device 112 may include, for example, one or more than one sensor and/or one or more than one emitter, as will be described in more detail later. The portion of the training data provided by the locating device 112 may be synchronously related to the portion of the training data provided by the training device 302 by means of a timestamp.

The training data may optionally have activity-specific process parameters, as will be described in more detail later. Activity-specific process parameters may represent the parameters of the respective function and/or operating point of the process tool, e.g. a volume flow of the paint spray gun.

Based on the training data and the optional activity-specific process parameters, a model 104m of the process activity (also referred to as a process model 104m) may be ascertained at 303. This process model 104m illustratively describes the movement of the process tool 124w to be performed to complete the process task. The process model 104m may optionally be examined and adjusted by a person 106.

In one example, the incoming training data has time-based motion data of the training device 302 guided by the person 106 and activation data of the input device 108. Subsequently, the time sequence of the training data is decomposed into sub-processes (e.g., approaching the starting point of the trajectory, taking the starting position, starting the painting process, painting, completing the process, departing from the end point of the trajectory), for example, via support points and/or via task-specific analytical algorithms. Optionally, manual post-processing of the training data may be performed by the user. Subsequently, an instance of a process model 104m, e.g. in the form of a metamodel, is generated. The metamodel describes the data types of the model instance as well as their possible relations. In this case, a model is exemplarily a directed graph with typed nodes. Nodes have a data type (node of the metamodel), which describes the parameters of the model and their value ranges. The generation of the model instance based on the training data is done using, for example, artificial neural networks. The artificial neural networks (kNN) may be trained using conventional training methods, for example the so-called backpropagation method. Alternatively or additionally, the training data may be optimized using mathematical optimization and/or machine learning methods. In training, the training vectors are selected according to the particular input parameters desired, such as spatial coordinates of the training device 302 (or changes thereof over time), associated timing, inputs to the training device 302 that may represent, for example, operating points and/or control points of the process tool, spatial orientation of the training device 302, etc. It should be noted that both the parameters included in the input vector the kNN and the parameters included in the output vector of the kNN are highly application-dependent and process-dependent, respectively, and are selected accordingly.

Further, a specific hardware platform 114 (more generally referred to as a machine 114) may be selected (e.g., a specific robot type or end effector, etc.). The machine specifics (e.g., structure) of the machine 114 may be taken into account using a model 114m of the machine 114. The model 114m of the machine 114 may have machine-specific information of one or more different machines 114. The machine-specific information may have machine-specific characteristics, such as positioning and repeat accuracies, maximum range of motion, speeds, acceleration, and so forth. Alternatively or additionally, the machine-specific information may represent at least the process tool 124w (also referred to as machine tool 124w) attached to, for example, the positioning device 114p of the machine 114.

Based on the model 114m of the machine 114 and the process model 104m, a platform-specific model 116m (also referred to as a control model 116m) for the machine controller 702 may be generated in 305. The control model 116m may have the respective control information that controls the movement and/or activity of the machine 114. For example, this may involve ascertaining the machine-specific control information (e.g., volumetric flow rate at the painting effector and/or motion sequences) that corresponds to the activity-specific process parameters.

However, the process model 104m need not necessarily be ascertained separately. Based on the training data and the optional activity-specific process parameters, the control model 116m may also be ascertained directly in 305 by, for example, mapping the trajectory 111 of the training tool 214 to a trajectory 113 of the process tool 124w.

In 307, a program code 116 (e.g., source code) may optionally be generated based on the control model 116m using a code generator 412. The program code 116 may denote the particular code in which the control program 116 is written. Depending on the process task, information technology infrastructure, and the specific requirements, various target platforms on which the program code 116 is to be performed may be served. In this context, the program code 116 may be generated for a communicating overall system (e.g., the robot controller and the PLC controller). The program code 116 may optionally have predefined portions to which the program code 116 may be customized by a developer.

Forming the program code 116 need not necessarily be done, as will be described in more detail later. For example, the control information of the control model 116m may be implemented directly by the control device 702 of the machine 114.

In an analogous manner, forming the control model 116m and/or the process model 104m need not necessarily occur. For example, processed training data may also be supplied to the control device 702 of the machine 114 as control information, which is then interpreted by the control device 702 of the machine 114 and converted into control signals for driving the kinematic chain of the machine.

Code generation 107 may illustratively exhibit finding a transformation from the dependent model to the control language of a concrete manufacturer-specific machine control system. In one example, code generation 107 takes the form of templates that exist for a target language. These templates have instances of the platform-dependent model 116m as input and describe at the metamodel level how text fragments are generated from them. Furthermore, these templates have control structures (e.g., branches) in addition to pure text output. A Template engine has again a Template and an instance of the platform-independent model as input and produces from it one or more text files, which may be added to the program code 116. It is understood that any other form of code generation 107 may also be used, e.g., without using templates and/or based only on mathematical mappings.

By means of the code generation 107, a control program 116 may be formed that is executable by the corresponding machine 114.

Code generation 107 may be, for example, for a machine controller 702 and/or a PLC controller 702. For example, the code generation 107 may generate human-readable code segments (i.e., source code) and/or machine-readable code segments (i.e., machine code). The source code may be generated for different target languages, e.g., depending on which target language is suitable for the corresponding machine. Optionally, the source code may be subsequently adapted and edited, e.g. by a developer.

Thus, generating 305 the control model 116m may be based on the training data and a model 114m of the machine 114.

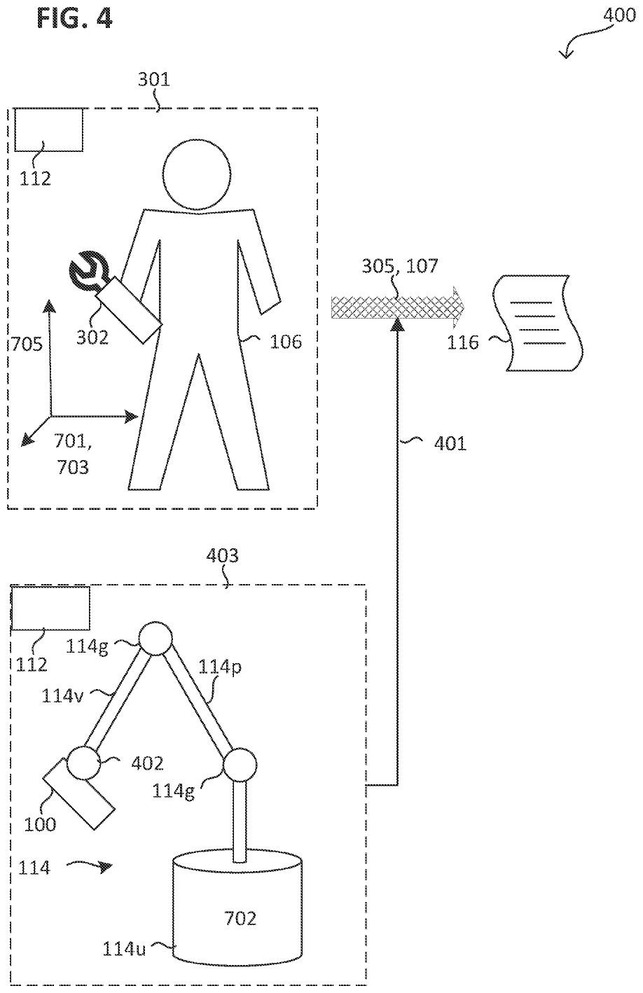

FIG. 4 illustrates the method 300 according to various embodiments in a schematic side view 400.

The method 300 may further include, in 401: Calibrating 403 the system 200. The calibrating may include performing a calibration sequence when the handheld device 100 is attached to the machine 114, such as to its manipulator. To this end, the system 200 may include an attachment device 402 by means of which the handheld device 100 may be releasably coupled to the machine 114. The fastening device 402 may, for example, be set up for magnetic fastening, for positive and/or non-positive fastening, e.g. by means of a clip by means of a Velcro strip or by means of another form-fitting element (e.g. screws).

The calibration sequence may include: Moving the end effector 114w of the machine 114, e.g., by controlling one or more than one (e.g., each) actuator of the kinematic chain of the machine 114; and capturing spatial information of the handheld device 100 (e.g., analogous to 301). For example, the position and/or motion of the handheld device 100 may be calibrated with respect to the coordinate system of the machine and/or a global coordinate system. Based on the information thus obtained, the model 114m of the machine 114 (for example, the control model, for example, a machine type-specific model or delta model) may be updated 401.

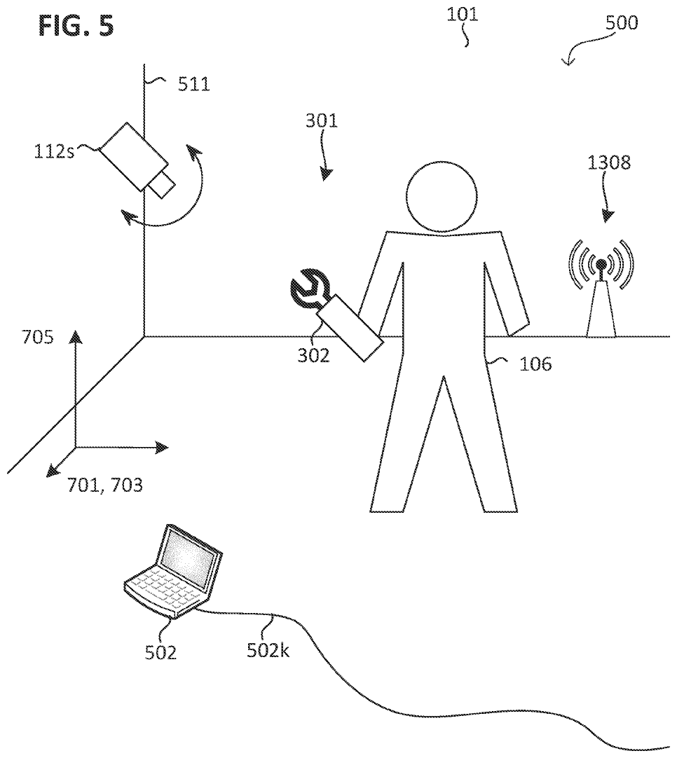

Optionally, program code 116 may be generated subsequently. The program code 116 may then be generated 107 based on the updated model 114m of the machine 114. However, the program code 116 need not necessarily be generated. For example, the learned code may be executed directly on the control device of the data processing system 502 (cf. FIG. 5) to control the machine, as will be described in more detail below.

The calibration sequence may illustratively provide a calibration of the robot 114 in the global coordinate system.

The method 300 may include, as an alternative or in addition to calibrating 403 the system 200, the following: Executing the control information to be communicated to the machine 114 (e.g., in the form of the program code, in the form of the process model 104m, and/or in the form of the training data) using the model 114m of the machine 114. In which, the model 114m of the machine 114 may be configured to emulate the operation of the machine 114. For example, the model 114m of the machine 114 may include a virtual image of the machine 114.

Illustratively, this may provide, by means of the model 114m of the machine 114, a test instance on which the control information may be tested for the degree of its integrity, task completion, and/or freedom from conflict.

Optionally, based on a result of executing the control information using the model 114m of the machine 114, adjusting the control information may be performed, e.g., manually and/or automatically. This makes it possible to increase the degree of integrity, the degree of task completion, and/or the degree of no conflict.

FIG. 5 illustrates the system 200 according to various embodiments in a schematic perspective view 500, which further includes a device external to the handheld device. The device external to the handheld device may include a data processing facility 502 that is configured to generate program code 116 or, more generally, to generate control information 107, as will be described in more detail later. To this end, the training data may be provided to the data processing facility 502, for example, by being transmitted to the data processing facility 502 by the location device 112 and/or the handheld device 100. The transmitting may be done, for example, according to a wireless communication protocol.

The data processing system 502 may be separate from the machine 114 or may be part thereof. For example, the data processing system 502 of the machine 114 may include or be formed from its control apparatus, e.g., including a programmable logic controller. Illustratively, the training data may be processed on a data processing system 502 separate from the machine and later transferred to the robot controller. Alternatively or additionally, the training data may be processed (e.g., partially or completely) on the robot controller itself. Similarly, if, for example, the generation of the program code 116 is omitted, the machine may be controlled directly by means of the data processing system 502, which is separate from the machine. In the latter case, the data processing system 502 may determine one or more than one control command based on the control information and drive the machine using the control command, e.g., via a programming interface and/or using a programming communication protocol (API). Then, steps 305, 307, 316 described in more detail below may be omitted.

In the following, reference is made to a data processing system 502 separate from the machine. By analogy, what is described may also apply to a data processing system 502 that is integrated into the machine 114 and/or provides the control commands directly to the machine.

The data processing system 502 may optionally be communicatively coupled 502k to the machine 114, for example, to the machine controller 702, for example, if the machine controller 702 is separate from the machine 114, or may be a component of the machine 114. The communicative coupling 502k may be provided, for example, by means of a cable 502k, or alternatively may be wireless. By means of the coupling 502k, the control of the machine 114 may be performed, for example, according to the calibration sequence. Alternatively or additionally, by means of the coupling 502k, the generated program code 116 may be transmitted to the machine 114. Communicating with the machine 114 may be done according to a communication protocol of the machine, e.g., according to a programming communication protocol, a network communication protocol, and/or a fieldbus communication protocol. Code generation 107 and/or communicating with machine 114 may thus be provided for one or more than one machine 114, optionally of different types, optionally taking into account possible different PLC control systems.

The data processing system 502 may, when it receives a first activation information, start recording the training data (also referred to as activating the training). Recording of data by the data processing system 502 may, of course, begin earlier. The training data then denotes that portion of the data that is also used for training. For this purpose, filtering of the recorded data may be performed, for example manually or on a tablet.

The data processing system 502 may, when it receives a second activation information, stop recording the training data (also referred to as deactivating the training). The activation and deactivation may be repeated and the training data thus recorded may be consolidated. Program code 116 may then be generated 107 based on the training data.

For example, the data processing system 502 may enable a software-based method 300 for teaching an industrial robot 114 that is accessible to a technical layperson 106. For example, a non-programmer 106 may be enabled to teach an industrial robot 114 in a fully integrated manner.

By means of the method 300, at least one task expert 106 (e.g., a mechanic or a welder) may demonstrate one or more than one activity of the process flow by way of example using the training device 302. Based thereon, the necessary control software 116 of the robot 114, including all required software components, may be generated in a fully automated manner.

The method 300 may include in 301: Capturing the training data using one or more sensors of the locating device 112 and/or the training device 302 (e.g., its handheld device 100). For example, the handheld device 100 may provide its location and/or acceleration as part of the training data. Alternatively or additionally, at least one sensor of the locating device 112 (also referred to as an external sensor) may provide the location and/or acceleration of the training tool 214 and/or the handheld device 100 as part of the training data. Other metrics may also be captured that represent an actual state of the training tool 214 and/or the handheld device 100, such as their trajectory 111 (e.g., position and/or motion). Optionally, the input unit 108 may include at least one sensor that captures a handling according to the activity as part of the training data. The training data may be transmitted to the data processing unit 502 (e.g., a PC, a laptop, etc.), which is communicatively connected by means of its communication unit (e.g., by radio) to the location device 112 and/or to the handheld device 100 (e.g., its output unit 110).

The locating device 122 may optionally emit a locating signal using a locating signal source 1308 (e.g., an infrared laser), as will be described in more detail later.

Optionally, the data processing system 502 may implement a system management system by means of which the components of the system may be managed and/or registered. For example, a component that logs into the system may be or become registered as a component of the system, such as the handheld device 100 and/or the interchangeable attachment 210. Thus, multiple interchangeable attachments 210 and/or multiple handheld devices 100 may be managed per system.

Reference is made herein to the input unit 108 being a component of the handheld device 100 (also referred to as an input unit 108 internal to the handheld device). The described may apply by analogy to an input unit external to the handheld device. For example, the input unit external to the handheld device may be or may be provided as an alternative or in addition to the input unit 108 internal to the handheld device. For example, the input unit external to the handheld device may be provided by means of a device external to the handheld device (also referred to as an activation device external to the handheld device). For example, the activation device external to the handheld device may include or be formed from a smartphone, a wireless switch, an interchangeable attachment (as will be described in more detail later), or the or an additional computing system 502. The input unit external to the handheld device may illustratively provide the same function as the input unit 108 internal to the handheld device, such that inputting activation information for activating the training of the machine is performed using the input unit external to the handheld device. The input unit external to the handheld device need not necessarily be a physical input unit, but may also be an emulated or virtual input unit.

For example, the activation device external to the handheld device may be registered with the system and optionally exchange data with that component of the system (also referred to as the processing component) that records and/or processes the training information, such as wirelessly. For example, the processing component of the system may be the control device of the handheld device 100 if it includes the data processing facility 502, or the control device of the machine if it includes the data processing facility 502. Alternatively, the activation device external to the handheld device may record and/or process the training information itself.

In general, the system may include one or more than one device external to the handheld device, at least one of which devices external to the handheld device process the training data (i.e., provides the processing component) and at least one or the device external to the handheld device optionally provides the input unit.

For example, the activation device external to the handheld device may allow ambidextrous training of the machine.

Analogously, the activation device external to the handheld device may include an output unit external to the handheld device, which may be or may be provided alternatively or in addition to the output unit 110 of the handheld device 100 (also referred to as the output unit internal to the handheld device). The output unit external to the handheld device may be configured to output the activation information for activating the training of the machine 114.

The input unit (internal and/or external to the handheld device) may optionally implement voice control or gesture control for inputting activation information. Alternatively or additionally, the handheld device 100 and/or the activation device external to the handheld device may implement voice control or gesture control for inputting training information. For example, voice-based or gesture-based input of one or more parameters of the activity to be trained (e.g., activity-specific and/or tool-specific process parameters) may be enabled by the user. For example, the user may specify a flow rate in a voice-based or gesture-based manner.

Alternatively or in addition to the gesture control, a muscle tension control may be implemented, for example. This may, for example, enable gestures or the parameter to be captured based on the user's muscle tension. The gesture control may be implemented, for example, by means of the muscle tension control and/or also by means of a video camera, which capture the behavior of the user.

More generally, the activation information and/or the one or more than one parameter of the activity to be trained may be ascertained based on (e.g., non-contact) captured user behavior (e.g., speech, facial expressions, gestures, motion, etc.). For example, the user behavior may be used to ascertain that training is to be started, interrupted, and/or terminated.

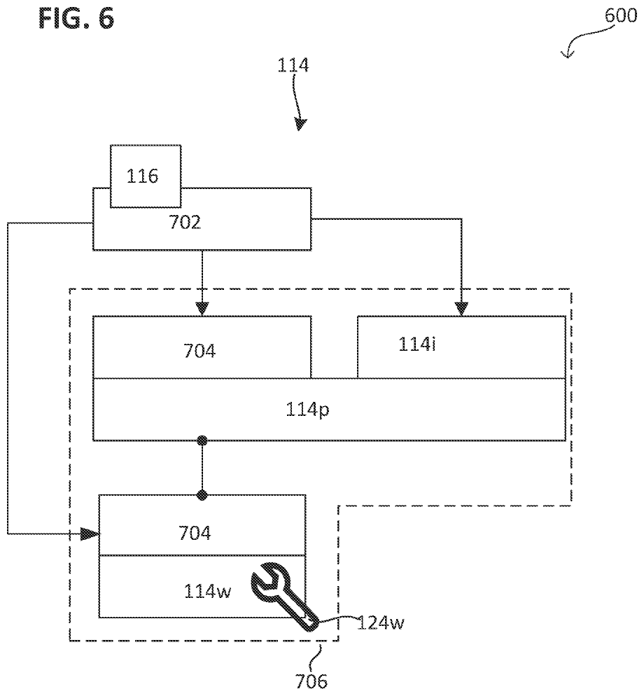

FIG. 6 illustrates a machine 114 according to various embodiments in a schematic body diagram 600.

The machine 114 may be a programmable machine herein by means of a control program 116. Once programmed, the machine 114 may be configured to autonomously perform one or more than one process activity, and optionally vary the process activity (i.e., task execution) within limits depending on sensor information. For example, the control device 702 may include a programmable logic controller (PLC).

The machine 114 may include a control device 702 configured to control at least one actuator 704 (also referred to as an actuator) of the machine 114 in accordance with the control program 116. The control device 702 may include, for example, one or more of a processor and/or a storage medium. The manipulator of the machine 114 may include a kinematic chain 706 along which an action of the at least one actuator 704 is transmitted, for example, along coupling links of the kinematic chain 706 to each other.

The kinematic chain 706 may include a positioning device 114p and an end effector 114w positionable by means of the positioning device 114p. The end effector 114w may be understood as the last link of the kinematic chain 706 of the machine 114, which is configured to act directly on a workpiece, for example, to process it (i.e., to process it). The sum of all operations, such as acting on the workpiece, for example a preparation step thereto, or for example a post-processing step thereto, may be part of the process activity. The process activity may include, for example, a primary forming step, an inspection step, a joining step (e.g., welding, coating, bolting, inserting, contacting, bonding, or otherwise assembling or assembling), a separating step (e.g., grinding, milling, sawing, or otherwise machining, punching, or disassembling), a forming step, a heating step, a displacing step (e.g., gripping, loading, rotating, or displacing), or the like. The process activity may be path-based, i.e., mapped by means of moving the end effector 114w along a trajectory 113.

The positioning device 114p may include at least one actuator 704 configured to move the end effector 114w to a position (also referred to as positioning). The end effector 114w may include at least one actuator 704 configured to perform the process activity, for example, by means of a tool 124w of the end effector 114w. The tool 124w may generally provide a function that corresponds to the process activity, by means of which the workpiece is acted upon. For example, the tool may include a forming tool, a joining tool (e.g., screwdriver, glue gun, or welder), a displacement tool (e.g., gripper), a cutting tool, or the like. The joining tool may, for example, include or be formed from a coating tool (e.g. a paint gun, a powder coating gun).

Optionally, the machine 114 may include at least one internal sensor 114i that is configured to capture an operating point of the kinematic chain 706, for example, to implement closed-loop control. For example, the internal sensor 114i may be part of a stepper motor that captures its current operating point (e.g., its position). Alternatively, or in addition to the at least one internal sensor 114i, the machine 114 may include external sensor 114i from its frame and/or end effector, such as a camera that visually captures the machine 114.

If the process activity is emulated by the programmable machine 114, the machine 114 as a whole may be brought to an operating point which is as close as possible to the process activity according to the spatial information. The operating point may, for example, define the position to which the end effector 114w is to be brought (by means of moving it) and the effect it is to provide there. The operating point may, for example, describe the sum of states of the individual actuators 704 of the machine 114.

The storage medium may be or may be provided as part of the control device 702 and/or separately therefrom. For example, the storage medium may include a semiconductor electronic storage medium, e.g. a read-only memory (ROM) or random access memory (RAM), have a memory card, have a flash memory, have a stick for a universal serial bus (USB stick), have a solid state drive (SSD), have a hard disk drive (HDD), have a memory disk (MD), have a holographic storage medium, have an optical storage medium, have a compact disc, have a digital-versatile disc (DCV), and/or have a magneto-optical disk.

Above, training has been described with reference to one machine 114. By analogy, what has been described may apply to a plurality of separate machines 114 (e.g., a process line), e.g., communicating with each other, as well as to a machine having a plurality of positioning devices and/or end effectors.

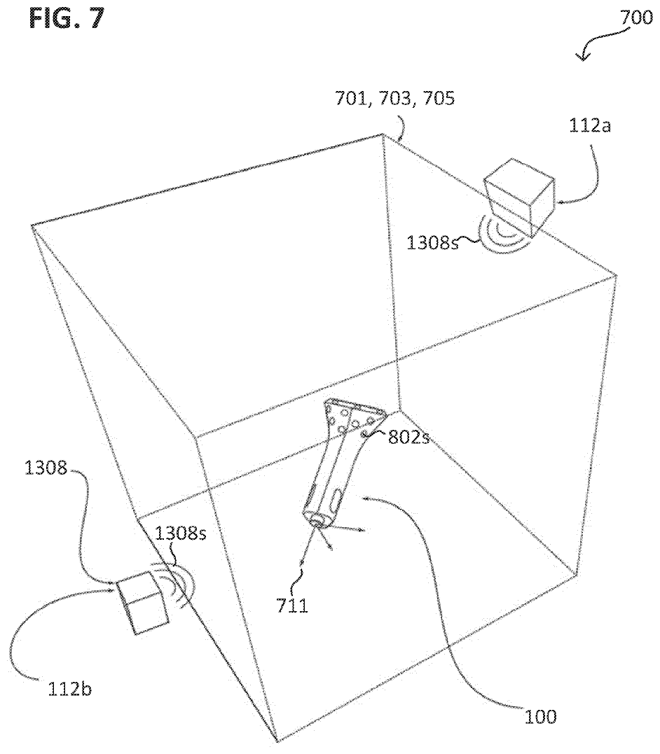

FIG. 7 illustrates a system 700 according to various embodiments in a schematic perspective view, e.g. set up like the system 200, wherein the system 700 includes the handheld device 100 and a locating device 112, wherein the locating device 112 includes a plurality of locating units 112a, 112b. Each of the locating units 112a, 112b may be configured to perform a location determination of the handheld device 100, for example by means of tracking (the so-called “tracking”). Alternatively or additionally, the handheld device 100 itself may be configured to perform a location determination. For example, the locating units 112a, 112b may be configured to project an optical pattern into space (e.g., by means of an infrared laser), which may be captured by one or more than one optoelectronic sensor of the handheld device 100.

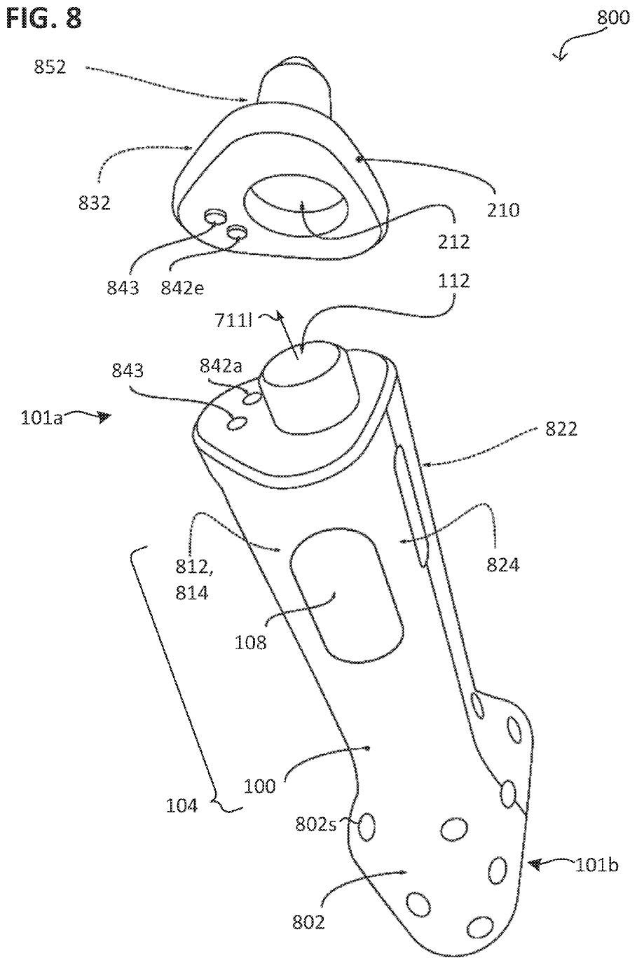

FIG. 8 illustrates a system 800, e.g., set up like system 200 or 700, according to various embodiments in a schematic perspective view. Along the longitudinal direction 711a, the handheld device 104 may be bounded by two end faces 101a, 101b, a second end face 101b of which faces the coupling structure 102 and includes a sensor portion 802 (more commonly referred to as a location portion 802). The longitudinal direction 711a of the handheld device 100 may be directed from the second end face toward the first end face 101a. The sensor section 802 may have one or more than one (e.g., optoelectronic) sensor, as described above, that may be used to determine the training trajectory 111, e.g., at least 3 (4, 5, or at least 10) sensors.

Alternatively, or in addition to the sensors, one or more than one emitter may be disposed in the locating portion 802 (also then referred to as the emitter portion 802 as), which communicates with the locating device 112. The locating device 112 may then supply the signals received from the emitters to the capturing of the spatial information of the handheld device 100. In the following, reference will be made to the sensors of portion 802. By analogy, what is described for the sensors of portion 802 may also apply to the emitters of emitter portion 802, in which case, for example, the signal direction would be reversed.

The more sensors the sensor portion 802 has, the greater the accuracy of the position determination may be. Optionally, at least two (or more in each case in pairs) sensors of the sensor portion 802 may differ from each other in their orientation. This facilitates an all-around capture.

The handle 104 may have a smaller circumference (e.g., along a self-contained path that is transverse to the longitudinal direction 711a) than the sensor portion 802. In other words, the sensor portion 802 may be flared. Alternatively or additionally, at least two sensors of the sensor portion 802 may have a distance (also referred to as sensor spacing) from each other that is greater than an extent of the handle 104 (also referred to as transverse extent). The transverse extent and/or the sensor spacing may be transverse to the longitudinal direction 711a and/or parallel to each other. This increases the accuracy of the position determination. Illustratively, the accuracy may increase as the inter-sensor spacing increases and/or as the area spanned by the sensors (also referred to as the sensor area) increases.

Optionally, one or more than one sensor of the handheld device used to determine the training trajectory 111 may be disposed within the handle 104, e.g., a rotation sensor 812 and/or an attitude sensor 814. The increases the accuracy of determining the training trajectory 111, e.g., due to the distance from the sensor portion 802.

Locating the sensor portion (e.g., with optoelectronic sensors) on the second end face 101b and/or away from the handle minimizes occlusion of the sensors of the sensor portion, thereby facilitating the determination of spatial information.

The handheld device 100 may include one or more than one feedback unit (also referred to as a signal generator), e.g., a visual feedback unit 822 (e.g., including a light source), e.g., a haptic feedback unit 824 (e.g., including a vibration source, e.g., including an unbalanced motor), and/or an acoustic feedback unit (e.g., including a speaker).

The interchangeable attachment 210 may optionally include a circuit 852 configured to implement a function. The function of the interchangeable attachment 210 may be set up according to the activity to be trained and/or may be controlled by means of a handling of the handheld device 100 (e.g., its input unit 108). Alternatively or additionally, the interchangeable attachment may include an input unit by means of which, for example, a handling according to the activity may be captured or the function of the interchangeable attachment may be operated.

For example, the function of the interchangeable attachment 210 may be controlled by means of the input unit of the interchangeable attachment 210 and/or the handheld device 100 (more generally, the training device 302). For example, a gripping movement of a gripper may be triggered and/or controlled by means of the input unit.

Examples of the function of the interchangeable attachment 210 may include: capturing a physical quantity acting on the interchangeable attachment 210 (for this purpose, the circuit may include at least one sensor), emitting radiation (for this purpose, the circuit may include at least one radiation source, e.g., a light source), exchanging data (for this purpose, the circuit may include at least one auxiliary interface), moving one or more than one component of the interchangeable attachment 210. For example, the function may be configured according to the process activity.

The handheld device 100 may be configured to supply power to and/or exchange data with the circuit 852. For example, the sensor of the circuit 852 may be read out and the read out data may be transmitted to the data processing system by means of the output unit 110. For example, the radiation source may be adjusted (e.g., its radiation intensity, its beam angle, its radiation wavelength, etc.). For example, the radiation source may include a light source, an ultraviolet radiation source (e.g., for curing adhesive), or thermal radiation source (e.g., a radiant heater). By means of the light source (illustratively emitting visible light), for example, an illuminated area may be projected onto the workpiece, which is used, for example, for inspecting the workpiece or marks a location on the workpiece that is to be machined.

Providing power to the circuit 852 and/or exchanging data with the circuit 852 may be accomplished, for example, in a wired manner (using a contact-interchangeable interface). To this end, the handheld device 100 may have, for example, a power line whose output 842a provides a first contact at the first end 101a of the handheld device. Correspondingly, the circuit 852 may have a power line whose input 842e provides a second contact. The first contact and the second contact, when the interchangeable attachment 210 is coupled to the handheld device 100, may be electrically and/or physically connected to each other (also referred to as a power supply connection). Similarly, a data exchange connection may be provided using contacts 843. Alternatively or additionally, the interchangeable attachment 210 may include an electrical power source (e.g., a battery) configured to provide power to the circuitry 852.

More generally, the interchangeable attachment 210 and the handheld device 100 (e.g., their batteries) may exchange electrical energy to power, for example, the interchangeable attachment 210 to the handheld device 100 or vice versa. For example, the interchangeable attachment 210 may also be used to charge the battery of the handheld device 100 or be operated autonomously from the battery of the handheld device 100.

In the same manner, the interchangeable attachment 210 and the handheld device 100 may exchange data, for example, from the interchangeable attachment 210 to the handheld device 100 or vice versa. For example, the function of the input unit 108 of the handheld device 100 may be transferred to an input unit of the interchangeable attachment 210 so that input of activation information for activating the training of the machine may be performed (for example, selectively or only) at the interchangeable attachment 210. The input unit of the interchangeable attachment 210 may, for example, exchange data with the control device of the handheld device 100 by means of contacts 843.

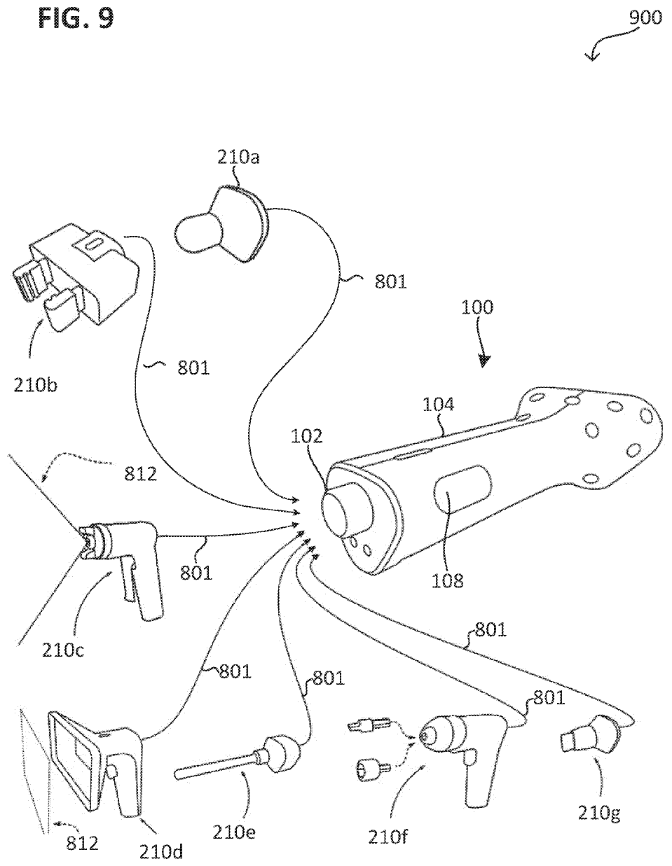

For example, the interchangeable attachment 210 may also include a sleeve into which the handle and/or the input unit 108 of the handheld device 100 may be at least partially (i.e., partially or completely) inserted and/or which at least partially covers them (see, for example, interchangeable attachment 210f in FIG. 9). For example, the sleeve may include a recess into which the handle and/or input unit 108 of the handheld device 100 may be inserted. This allows for more customization of the training device 302 to the activity being trained. Optionally, such an interchangeable attachment 210 may be configured to take over the function of the input unit 108 when coupled to the handheld device 100, so that the input of the activation information for activating the training of the machine may be performed at the interchangeable attachment 210.

However, the data exchange connection and/or power supply connection may also be wireless (using a wireless interchangeable interface). For example, power may be wirelessly coupled into the circuit 852 using induction. For example, the data may be exchanged wirelessly, such as via Bluetooth and/or RFID. Alternatively or additionally, the data (e.g., in the form of a data signal) may be modulated onto a signal (e.g., the current and/or voltage) of the power supply connection (also referred to as carrier frequency technology). For example, the data signal may be modulated onto one or more than one carrier signal of the power supply connection.

For example, the coupling structure 102 and the mating coupling structure 212 may provide a plug-in coupling.

FIG. 9 illustrates a system 900, e.g., set up like one of systems 200, 700, or 800, according to various embodiments in a schematic perspective view, wherein the system 900 includes the handheld device 100 and a plurality of interchangeable attachments 210a to 210g. Of the plurality of interchangeable attachments 210a to 210g, one interchangeable attachment may be or may be selectively (e.g., always exactly) coupled to the coupling structure 102.

For example, the plurality of interchangeable attachments 210a to 210g may include an interchangeable attachment 210b having a displacement tool (also referred to as a pick-and-place tool), such as a gripper. The relocation tool may, for example, have interchangeable gripper jaws, have two or more gripper jaws, and/or have a powered gripping function. To this end, its circuit 852 may include, for example, an actuator that drives the gripping function (e.g., a gripper adjustment).

For example, the plurality of interchangeable attachments 210a to 210g may include an interchangeable attachment 210c with a coating tool. This may include, for example, a sensor that captures a flow regulation to be trained.

The plurality of interchangeable attachments 210a to 210g may include, for example, an interchangeable attachment 210d having an inspect tool. The inspect tool may represent, for example, an optical quality assurance activity. For example, the area to be inspected may be projected onto the workpiece using the inspect tool.

For example, the plurality of interchangeable attachments 210a to 210g may include an interchangeable attachment 210e having a cutting tool, such as a deburring tool. The circuitry 852 thereof may include, for example, a multi-axis force sensor, a variable stiffness, and/or a replaceable deburring tip. The multi-axis force sensor may, for example, capture a force acting on the deburring tip. For example, the stiffness may represent a force that opposes deflection of the deburring tip relative to the multi-axis force sensor.

The deburring tool may represent, for example, deburring as an activity.

For example, the plurality of interchangeable attachments 210a to 210g may include an interchangeable attachment 210f having a screwdriving tool. Circuitry 852 thereof may include, for example, a sensor (e.g., a single or multi-axis force sensor) capable of capturing a force applied to the screwdriving tip. For example, the screwdriving tool may include a replaceable screwdriving tip (the screwdriving end effector, e.g., a screwdriving bit).

The plurality of interchangeable attachments 210a to 210g may include, for example, an interchangeable attachment 210g having an adhesive tool. The adhesive tool may include, for example, a replaceable adhesive tip. The circuit 852 of the interchangeable attachment 210g may include, for example, a sensor capable of capturing a working area swept by the adhesive tip, and/or a sensor (e.g., a single or multi-axis force sensor) capable of capturing a force applied to the adhesive tip.

For example, the circuit 852 of the interchangeable coating tool and/or inspecting tool attachment may include a work area display unit that displays the work area 812, e.g., by illuminating it using a light source of the work area display unit. The size of the displayed work area may optionally be changed, and the actual set work area or work point may be taken into account during training to form the control model 116m.

The circuit 852 of the interchangeable attachment with coating tool, screwing tool, displacement tool, and/or with inspecting tool may have the additional interface, for example.

The additional interface may, for example, have an additional input unit that is set up to input information about an operating point of the tool (also referred to as operating point information). The working point information may represent, for example, a start, a duration, and/or a strength of the activity, e.g., of a coating (e.g., the flow used for it). The additional input unit may, for example, include one or more than one switch, slider, force sensor, or the like. The additional interface may alternatively or additionally include an additional feedback unit configured to output feedback. The additional feedback unit may include, for example, a visual feedback unit (e.g., including a light source), e.g., a haptic feedback unit (e.g., including a vibration source, e.g., including an unbalance motor), and/or an acoustic feedback unit (e.g., including a speaker). The feedback unit may, for example, indicate a status of the operating point, acknowledge the change thereof, acknowledge the capture of a user input, acknowledge the (physical, electrical, and/or communication) coupling and/or uncoupling of the interchangeable attachment, acknowledge the capture of a mechanical action on the interchangeable attachment. The optical feedback unit may, for example, have a display or other indication.

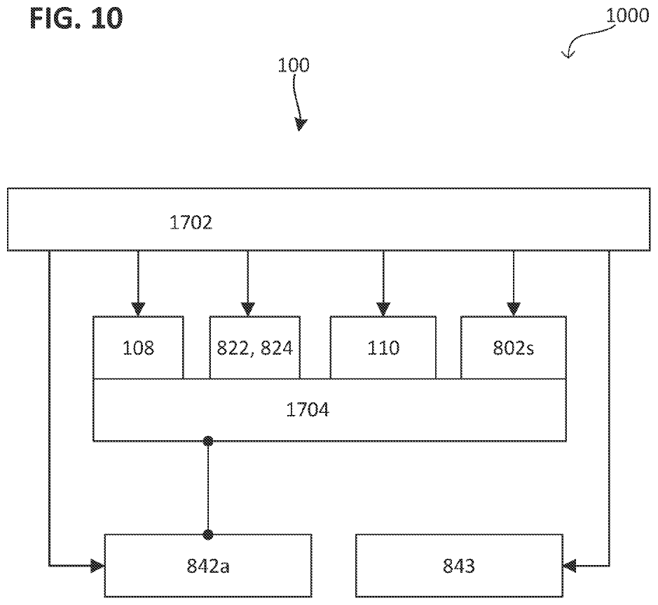

FIG. 10 illustrates the hand-held device 100 according to various embodiments in a schematic assembly diagram 1000.

The handheld device 100 may herein be a mobile device programmable by means of a control program. Once programmed, the handheld device 100 may be configured to autonomously capture at least portions of a process activity performed by means of the handheld device 100 and transmit the portions as training data by means of the output unit 110. The training data may include or be formed from the activation information and/or the spatial information. For example, the spatial information may include a position, movement, and/or orientation of the handheld device 100.

Alternatively or additionally, the handheld device 100 may be configured to be captured itself, e.g., its position, movement, and/or orientation.

The handheld device 100 may include a control device 1702 that is configured to read at least the input unit 108 and/or drive the output unit 110. For example, the control device 1702 may be configured to send the or any activation information captured by means of the input unit 108 according to a communication protocol by means of the output unit 110 (e.g., to the data processing system and/or a network). Examples of the input unit 108 may include: one or more than one switch (e.g., push button), e.g., a non-contact switch, a touch sensitive surface (e.g., resistive and/or capacitive), a virtual switch (e.g., implemented using a display).

For example, the output unit 110 may be a wireless output unit 110 and may optionally include a transceiver for receiving data. For example, the control device 1702 may exchange data with the data processing system and/or network using the transceiver of the output unit 110. For example, for the output unit 110 may have: a Bluetooth transceiver, a WLAN transceiver, a cellular transceiver.

Optionally, the output unit 110 may also be configured to register the handheld device 100 in the system. The registration may occur, for example, as soon as the handheld device 100 is turned on. Thus, the system may detect if or when the handheld device 100 is made ready for training at least one movement and at least one activity of the machine. Analogously, if the input unit is a component of a device external to the handheld device, the device external to the handheld device may be configured to register itself with the system or to manage the registration of the handheld device 100 (e.g., if the device external to the handheld device implements system management).

For example, the control device 1702 may include one or more than one processor and/or storage medium.

For example, the control device 1702 may be configured to capture the spatial information using one or more than one sensor 802s (if present) of the handheld device 100. For example, sensors of the handheld device 100 may include: a GPS sensor, an attitude sensor (e.g., including an orientation sensor and/or a position sensor), an acceleration sensor, a rotation sensor, a velocity sensor, an air pressure sensor, an optoelectronic sensor, a radar sensor.

For example, the control device 1702 may be configured to exchange data with an interchangeable attachment 210 coupled to the handheld device 100 using an interface 843 (if provided) of the handheld device 100.

For example, the control device 1702 may execute software that provides one or more than one of the above functions, includes a programming interface, and/or cyclically reads the status of the components of the handheld device 100.

The handheld device 100 may include a battery 1704 (e.g., an accumulator) configured to supply electrical energy to the electrical components 108, 110, 822, 824, 802s of the handheld device 100. Optionally, the handheld device 100 may include a charging port through which electrical energy may be externally supplied to the battery 1704 for charging the battery 1704.

For example, the battery 1704 may be configured to exchange energy with an interchangeable attachment 210 coupled to the handheld device 100 by means of an interface 842a (if provided) of the handheld device 100. The exchanging of energy may be controlled, for example, using the control device 702.

For example, a user input (e.g., force, repetition, speed, location, etc.) captured by the input unit 108 may be used to determine whether the user input meets a criterion. If the criterion is parameterized according to the type of input unit 108 (i.e., mapped to a property that may be captured by the input unit 108), the property captured by the input unit 108 may be compared to the parameterized criterion to determine whether the criterion is met. If the user input meets a first criterion, the first activation information may be captured. If the user input meets a second criterion, the second activation information may be captured. However, the functions provided by means of the input unit 108 may also be provided in whole or in part by means of the other device external to the handheld device, for example, by means of a wireless switch and/or by means of a mobile computing device (e.g., a tablet) on which, for example, an application emulating the functions of the input unit 108 is executed.

The handheld device 100 may optionally include one or more than one feedback unit 822, 824. For example, the control device 1702 of the handheld device 100 may be configured to output a feedback (e.g., haptic and/or visual) by means of the one or more than one feedback unit 822, 824. The feedback may, for example, represent a status of training, acknowledge a change thereof (e.g., activation or deactivation), acknowledge the capture of a user input, acknowledge the coupling and/or uncoupling (physically, electrically, and/or communicatively) of an interchangeable attachment, represent a status of the handheld device 100 (e.g., its battery charge), and/or acknowledge the capture of a mechanical action on the interchangeable attachment. Examples of the feedback unit 822, 824 include: a light source (e.g., a light emitting diode), a sound source (e.g., a speaker), a vibration source (e.g., an unbalanced motor).

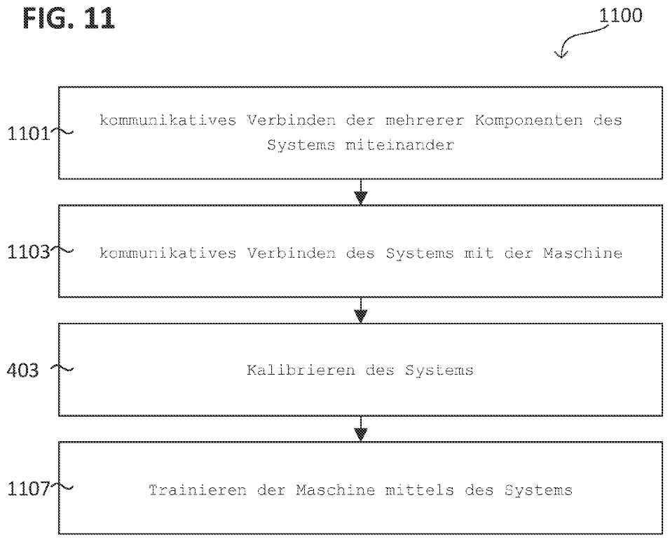

FIG. 11 illustrates the method 300 according to various embodiments in a schematic flowchart 1100. The method 300 may include: in 1101, first communicatively connecting the plurality of components of the system to each other; and second, in 1103, communicatively connecting the system to the machine. The first connecting may be, for example, wireless. The second connecting may be done, for example, by means of a cable, such as a network cable, connecting the machine to the data processing system. Optionally, the data processing system may be powered by the machine by means of the network cable.

The method 300 may optionally include: calibrating 1103 the system. By means of the locating device 112 (e.g., its locating signal), a position and/or movement of the handheld device may be captured (for example, its exact position in space may be ascertained). For this purpose, the handheld device may be attached to the machine using the attachment device. Depending on the type of machine, for example, different types of the mounting devices may be used. Capturing the handheld device may be done, for example, using infrared light (for example, a light pattern) emitted by the locating device 112. Calibration 1103 may be fully automatic, for example, when an input meets a predetermined criterion.

The method 300 may include in 1101: training the machine by means of the system. The person may couple a suitable interchangeable attachment to the handheld device and perform the activity by means of the training device thus formed. Optionally, the person may execute an application by means of the data processing system, by means of which various settings and/or information regarding the activity to be performed may be set. The training device may further include recording training data. For example, the training data may include spatial information with an accuracy of millimeters (or tenths of millimeters). The training data may optionally identify a captured mechanical interaction (e.g., a force) with the interchangeable attachment while performing the activity. For example, a force sensor of the handheld device may be used to capture a pressure of the activity acting on the interchangeable attachment. For example, the pressure level may be considered as a parameter of the activity when training a grinding process. The training may further include forming the control model based on the training data. The control model may have multiple pieces of control information that are executed sequentially in time. For example, a control information may represent to which working point the machine is to be brought.

The training may optionally include post-processing the training data, the control model, and/or the process model. For example, the reworking may be performed by a user interacting with the data processing system. Alternatively or additionally, the post-processing may be done by means of an artificial intelligence. This makes it easier to train more complex processes.

Training may further include generating the program code. For example, the program code may be generated in a programming language of the machine. The programming language in which the program code is written may be ascertained by the data processing system, for example, by ascertaining the type of machine.

The multiple components of the system may include the handheld device, the data processing system, the location device 112, and/or (e.g., if capable of communication) the removable attachment 210.

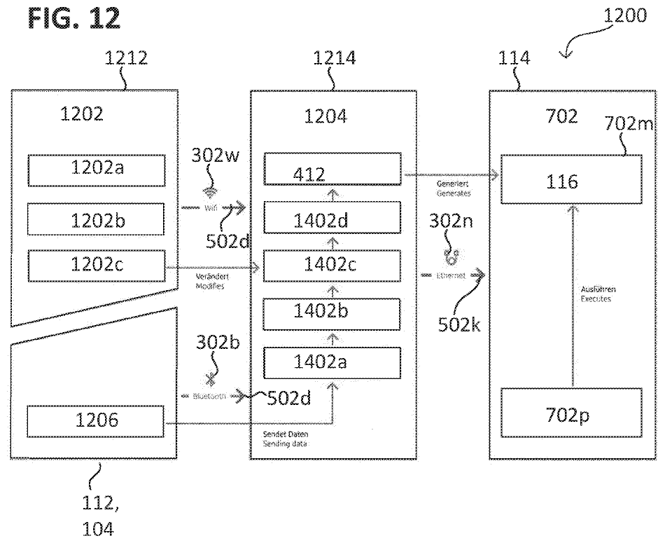

FIG. 12 illustrates a system 1200, e.g., set up like one of systems 200, 200, 700, 800, or 900, in a method 300 according to various embodiments in a schematic communication diagram 1200.

The data processing facility 502 may optionally include a mobile terminal 1212 (e.g., a mobile device, e.g., a tablet) on which a user interface 1202 (also referred to as a front-end) of the application is executed. The data processing system 502 may alternatively or additionally include a stationary terminal 1214 (e.g., a data processing system, e.g., a server) on which a substructure 1204 (also referred to as a back-end) of the application (e.g., a processing component) is executed.

For example, the stationary terminal 1214 may be wired 502k to the machine 114, e.g., by means of a network 302n. The stationary terminal 1214 may be, for example, wireless 502d (e.g., using WLAN 302w) and/or wired (e.g., using a long cable of the terminal 1214) to the mobile terminal 1212. For example, the stationary terminal 1214 may be wirelessly connected (e.g., using Bluetooth 302b) to processing software 1206 executing on, for example, the handheld device 100 and/or the locating device 112. The processing software 1206 may be configured to transmit the training data (or a pre-processed version thereof) to the back-end 1204. One or more than one (e.g., each) of the wireless links 302w, 302b, 302n may alternatively be or additionally be provided using a wired link, and vice versa.

Alternatively, or in addition to the terminal 1214, non-local logic (e.g., a cloud) may be used to provide the processing component. For example, a central server may be set up to provide a processing component to each of a plurality of systems. This saves resources. For example, in this case, the transfer of training data and/or control information to/from the processing component may be done over the Internet or in-network resources (e.g., EdgeClouds).

The front end 1202 (e.g., its user interface) may include a configuration and calibration manager 1202a, a training data visualization 1202b, and a process activity planner 1202c.

The back-end 1204 may include a processing component 1402a that collects the training data and/or performs the locating, e.g., ascertains the training trajectory 111 and/or the associated working points along the training trajectory 111 based on the training data. The back-end 1204 may include a process model generation component 1402b that ascertains the process model 104m based on the training trajectory 111 and/or the associated working points along the training trajectory 111. The back-end 1204 may include an optional process model adjustment component 1402c that modifies the ascertained process model 104m based on instructions originating from the process activity planner 1202c. The back-end 1204 may include a control model generation component 1402d that ascertains the control model 116m based on the process model 104m.

The back-end 1204 may include the code generator 412, which generates the program code 116 based on the control model 116m and stores it on a storage medium 702m (e.g., data storage) of the machine 114. A processor 702p of the control device 702 may read the storage medium 702m to execute the program code 116. As described above, the code generator 412 may be omitted, for example, if the control commands are transmitted directly to the machine without generating the program code.

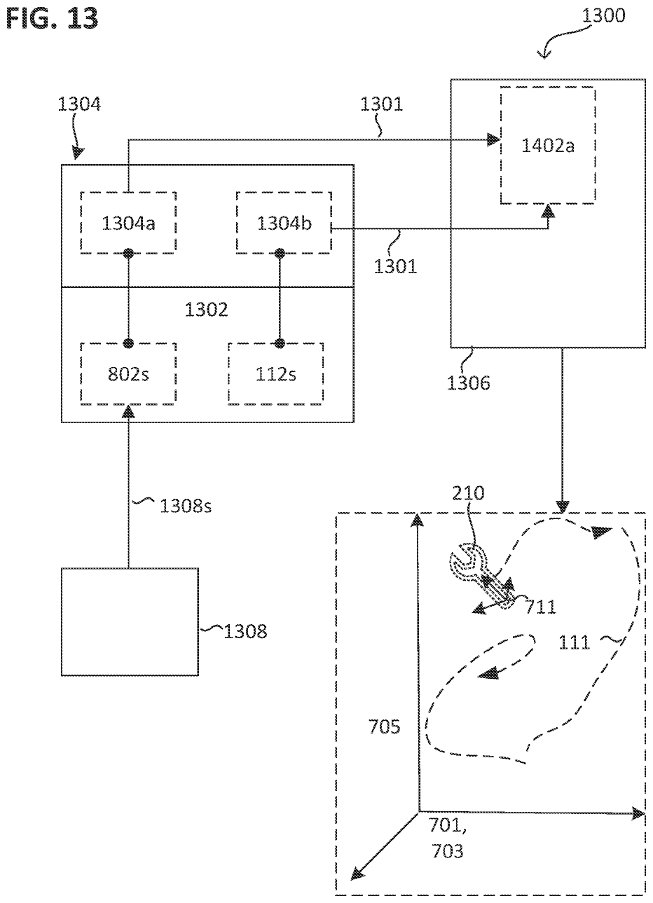

FIG. 13 illustrates a trajectory determination mechanism 1300 of the system 200 in a schematic communication diagram.

The trajectory determination mechanism 1300 may be configured to determine the training trajectory 111, e.g., based at least in part on the spatial information 1301 about the handheld device 100. The trajectory determination mechanism 1300 may include at least one measurement chain component 1304 and an evaluation component 1306. The measurement chain component 1304 may include a sensor arrangement 1302 and one or more than one transducer 1304a, 1304b.

The sensor arrangement 1302 (e.g., each of its sensors) may be configured to capture one or more than one metric representing (e.g., from which the spatial information about the handheld device 100 may be derived). For example, the sensors of the sensor arrangement 1302 may include internal sensors or may include external sensors that are registered (e.g., via a communication link) in the system.

A sensor (also referred to as a detector) may be understood as a transducer which is set up to capture a property of its environment corresponding to the sensor type qualitatively or as a measurand quantitatively, e.g. a physical or chemical property and/or a material composition. The measurand is the physical quantity to which the measurement by means of the sensor applies.

The or each measurement transducer 1304a, 1304b may be coupled to at least one sensor of the sensor arrangement 1302 and may be configured to provide a measurement value as an image of the captured measurement variable of the at least one sensor. The provided measured values (illustratively measured data) may be provided to the evaluation component 1306 as part of the training data. The measurement data may have concrete values about the spatial information, e.g., about a motion (e.g., rotation and/or translation) in space, a position in space, and/or an orientation in space.

For example, various physical quantities may be captured, such as a force caused by the movement or the change in an optical signal caused by the movement. For example, a camera may be used that captures a stream of image data of space in which the handheld device is located, and the image data may be used to ascertain spatial information about the handheld device. However, a distance between a reference point of the locating device 112 (e.g., its locating unit 112a) and the handheld device may also be measured, for example, using radar, lidar, or sonar. However, an orientation of the handheld device may also be captured, for example, using a tilt sensor of the handheld device. However, a photosensor of the handheld device may also be used, for example, to capture motion relative to an optical location signal (e.g., an optical pattern). For example, an inertial sensor of the handheld device may capture the current state of motion of the handheld device.

According to various embodiments, the components of the trajectory determination mechanism 1300 (e.g., sensors or transducers), may be distributed among various components of the system. For example, the training device 302 (e.g., the handheld device 100) may include one or more than one sensor 802s (also referred to as a trajectory sensor internal to the handheld device) of the sensor arrangement 1302 and/or one or more than one transducer 1304a. Alternatively or additionally, the device external to the handheld device (e.g., its locating device 112) may include one or more than one sensor 112s of the sensor arrangement 1302 (also referred to as the trajectory sensor external to the handheld device) and/or one or more than one transducer 1304a. For example, the evaluation component 1306 may be part of the data processing system 502, e.g., executed as a component of the application (e.g., as a processing component 1402a) by the data processing system 502, or may communicate the ascertained training trajectory 111 to the data processing system 502.

The evaluation component 1306 may be set up to determine the training trajectory 111 on the basis of the supplied measurement data 1301. For this purpose, the evaluation component 1306 may be set up to relate the measurement data to one another, to interpret them, to take into account their origin, to take into account their linkage with the spatial information about the handheld device, and so on. For example, results from measured values from different sensors may be superimposed on each other to produce a more accurate training trajectory 111. Knowing the linkage of the measured value to the spatial information, the measured value may be mapped to a value of the spatial information, e.g., a location coordinate and/or its change over time. The more sensors used, the more accurate the trajectory 111 may be.

Optionally, the trajectory determination mechanism 1300 may include one or more location signal sources 1308 external to the handheld device. The or each location signal source 1308 may be configured to emit a location signal 1308s, e.g., toward the handheld device and/or at least into space in which the handheld device is disposed. Multiple location signals 1308s may, for example, be superimposed on each other (see, for example, FIG. 7).

For example, the location signal 1308s may include an infrared signal (including light in the infrared range), an ultrasonic signal, a radio signal, and/or a visible light signal (including light in the visible range). For example, the ultrasonic signal may allow for high accuracy (for example, in a time-of-flight measurement). The infrared signal enables a low-cost implementation. Furthermore, the infrared signal does not require a direct connection between the transmitter and receiver, since the infrared signal may reach the receiver through reflections. Thus, it may at least be ascertained whether an infrared signal is present in a space. An electromagnetic locating signal (e.g., light signal, radio signal, infrared signal) may optionally have a transmitter identification modulated onto it, whereby different locating signal sources 1303 may be distinguished based on their locating signal. Unlike the infrared signal and visible light signal, a radio signal may penetrate walls and other obstacles, facilitating reception. The light signal may be captured even with a low-tech charge-coupled sensor. For example, the or each location signal source 1308 may include a laser scanner.

By means of one or more than one location signal 1308s, the spatial information may be ascertained based on, for example, one or more than one of the following measurement mechanisms: range mechanism, travel time mechanism, travel time difference mechanism, incidence angle mechanism, and/or signal strength mechanism. Knowing its position in space, the or each location signal source 1308 may serve as a reference point for the measurement mechanism. For example, a geometric relation (e.g., distance, angle, etc.) with respect to the reference point may be ascertained and, based thereon, the spatial information about the handheld device. Based on a distance to one or more than one location signal source, a position of the handheld device may then be ascertained. Optionally, based on the respective distance of two sensors of the handheld device, its orientation with respect to a location signal source may also be ascertained.

In the range mechanism, each location signal source 1308 may provide a cell of the size of the range of the location signal 1308s. For example, the captured cell may be associated with a location signal source and its position via transmitter identification, with the size of the cell placing an upper bound on the distance of the sensor 802 from the location signal source 1308. In the time-of-flight mechanism, the time difference between the transmission and reception of the location signal 1308s (also referred to as the time-of-flight) may be measured. The time difference may be associated with a location signal source and its position, for example, via transmitter identification, and converted to a distance from the location signal source. In the time-of-flight difference mechanism, the time-of-flight of two locating signals may be compared and, based on this, the distance to the corresponding locating signal sources may be ascertained. In the angle of incidence mechanism, the angle of incidence of the locating signal 1308s may be ascertained, which may be converted into an orientation, for example.

Based on multiple angles of incidence, a position may also be ascertained, for example. In the signal strength mechanism, the signal strength of the locating signal may be converted into a distance to the locating signal source.

Alternatively or additionally, the handheld device and/or its surroundings may be visually captured by the camera and the spatial information ascertained on this basis. Data from different sensors (e.g. image data and position data or image data and acceleration data) may also be superimposed to improve accuracy.

For example, the or each locating signal source 1308 may be provided as part of a locating unit 112a, 112b. The or each locating unit 112a, 112b may alternatively or additionally include at least one trajectory sensor 112s of the device external to the handheld device (also referred to as trajectory sensor 112s external to the handheld device).

As a result, the trajectory sensors 802s, 112s of the training device 302 and/or the locating device 112 capture and record time-based training data, for example at high frequency, describing the complete process activity.

Examples of a trajectory sensor 112s external to the handheld device include: a camera 112, a distance sensor 112, a sonar sensor 112, and/or a radar sensor 112. Examples of a trajectory sensor 802s internal to the handheld device include: a camera 112, a motion sensor (e.g., a rotation sensor, a velocity sensor, and/or an acceleration sensor), an inertial sensor, a position sensor (e.g., an orientation sensor and/or a position sensor), an infrared sensor, and/or an air pressure sensor. The position sensor may also include, for example, a GPS sensor. The alignment sensor may include, for example, a gyro sensor, a gravity sensor, and/or a magnetic field sensor (e.g., to determine alignment in the earth's magnetic field). For example, the barometric pressure sensor may enable determining information about a vertical position of the handheld device 100, enabling more accurate triangulation to be performed.

Determining the training trajectory 111 may be done, for example, by means of laser tracking (e.g., in the infrared range and/or by means of an infrared laser), by means of optical tracking (e.g., by means of a camera and/or pattern recognition), by means of radars (e.g., by means of a radar transceiver), by means of ultrasounds (e.g., by means of an ultrasound transceiver), by means of a global positioning system (GPS), by means of an inertial measurement unit (IMU) of the handheld device. For example, an IMU of the handheld device may include several different inertial sensors, such as one or more than one accelerometer and/or one or more than one rate-of-rotation sensor.

For example, the training trajectory 111 may represent a spatial distribution of the work location. The work location may denote the location in space 701, 703, 705 where an action of the process tool is to occur. For example, the work location may be stationary with respect to the training device 302 (e.g., the coordinate system 711). For example, the work location may be located at the tip of the training tool 210 and/or its position may be or become at least respectively dependent on the training tool 210 of the training device 302.

For example, the system may include a model of the training device 302 representing the training tool 214 (e.g., its type) coupled to the handheld device 100, wherein the model of the training device 302 may be taken into account when determining the training trajectory 111. For example, the model of the training tool 302 may indicate a position of the working point in the coordinate system 711 of the training tool 302. Alternatively or additionally, the model of the training device 302 may specify, for example, a location of the longitudinal direction 711a of the handheld device in the coordinate system 711 of the training device 302.

In one embodiment, the system includes a plurality of separate locating units 112a, 112b, each locating unit configured to emit a pulsed infrared signal as a locating signal. The or each pulsed infrared signal is captured by a plurality of separate sensor portion optoelectronic sensors. The measurement data ascertained on the captured infrared signal, together with data representing one or more than one inputs to the training device (e.g., the input unit of the handheld device and/or the interchangeable attachment), are transmitted to the stationary terminal as training data. The stationary terminal ascertains, based on the data and taking into account the interchangeable attachment of the training device, the training trajectory and optionally a working point for each point of the training trajectory. The working point is ascertained, for example, based on the handling of the function of the interchangeable attachment. Recording of the measurement data is started, for example, in response to actuation of the input unit of the handheld device.

In one embodiment, the handheld device may ascertain which interchangeable attachment the training device has (also referred to as interchangeable attachment identification), i.e. the type of interchangeable attachment may be ascertained. The interchangeable attachment identification is performed, for example, using RFID, e.g., by reading a radio tag of the interchangeable attachment. The radio tag may, for example, have and/or transmit a stored interchangeable attachment identifier, e.g. a number. Alternatively or additionally, the interchangeable attachment identification is performed by means of capturing a resistive resistance of the power supply connection in which the plurality of interchangeable attachments differ from each other. The interchangeable attachment identification is alternatively or additionally performed by means of capturing the function of the circuit of the interchangeable attachment. Which interchangeable attachment the training device has may also be indicated by means of a user input to the computing system. The result of the interchangeable attachment identification may be taken into account when determining the control model (e.g. the training trajectory).

In the following, various examples are described that relate to what has been described above and what is shown in the figures.

Example 1 is a handheld device for training at least one movement (e.g., a process movement) and at least one activity (e.g., a process activity) of a machine (e.g., at least its end effector), e.g., a processing machine, the handheld device including: a handle; an (e.g. an (e.g. optional) input unit configured for inputting activation information for activating the training of the machine; an (e.g. optional) output unit configured for outputting the activation information for activating the training of the machine to a device external to the handheld device (e.g. a data-processing device, a data processing device, a data storage device, etc.); wherein: the handheld device further includes a (e.g. front) coupling structure for releasably coupling an interchangeable attachment configured in accordance with the at least one activity, and/or the handheld device further includes a (e.g. front) tool (e.g. a processing tool) configured in accordance with the at least one activity.

Example 2 is the handheld device according to example 1 or 52, wherein the output unit is configured to communicate wirelessly with the device external to the handheld device (e.g., according to a wireless communication protocol), e.g., includes a wireless communication device for communicating with the device external to the handheld device.

Example 3 is the handheld device according to example 1 or 2, further including: a mechanical sensor configured to capture a mechanical action on the coupling structure, wherein the output unit is configured to output an action information about the captured mechanical action to the device external to the handheld device.

Example 4 is the handheld device according to example 3, wherein the mechanical sensor includes a force sensor and/or a torque sensor.

Example 5 is the handheld device according to any of examples 1 to 4 or 52, further including a battery and/or a power supply connector, which is/are configured to supply, for example, the output unit, the interchangeable attachment and/or the input unit with electrical energy, wherein optionally the battery may be charged by means of the power supply connector.

Example 6 is the handheld device according to any of examples 1 to 5, which is further configured to identify the interchangeable attachment, for example the output unit being configured to transmit a result of the identification to a device external to the handheld device; the handheld device for example including a sensor configured to detect a (e.g. physical) property and/or (e.g. digital) signature of the interchangeable attachment, the handheld device for example including a processor configured to, based on the property and/or signature of the interchangeable attachment, identify the interchangeable attachment (i.e. recognize it among other interchangeable attachments).

Example 7 is the handheld device according to any of examples 1 to 6 or 52, wherein the input unit is configured to capture a handling of the handheld device while performing the activity.

Example 8 is the handheld device according to any of examples 1 to 7 or 52, wherein the input unit includes a switch.

Example 9 is the handheld device according to any one of examples 1 to 8 or 52, further including: a feedback unit configured to output feedback to a user of the handheld device.

Example 10 is the handheld device according to example 9 or 52, wherein the feedback includes a haptic and/or visual signal.

Example 11 is the handheld device according to any of examples 1 to 10 or 52, further including: one or more than one first sensor configured to capture a location signal (e.g., electromagnetic) external to the handheld device; and/or one or more than one additional first sensor configured to capture spatial information about: a movement of the handheld device in space, a position of the handheld device in space, and/or an orientation of the handheld device in space.

Example 12 is the handheld device according to example 11, wherein the one or more than one first sensor for capturing the location signal includes at least one of: an optoelectronic sensor (e.g., a lidar sensor, light sensor, or infrared sensor); and/or a radio wave sensor (e.g. a radar sensor) for capturing the location signal; wherein the one or more additional first sensors includes at least one of: a motion sensor; a position sensor; and/or an air pressure sensor; wherein, for example, the handheld device is configured to determine the spatial information based on the location signal.

Example 13 is the handheld device according to example 12, wherein the motion sensor includes an accelerometer, rotation sensor, and/or velocity sensor; wherein the position sensor includes an orientation sensor (e.g., tilt sensor and/or gyro sensor) and/or a position sensor; wherein the optoelectronic sensor includes an infrared sensor.

Example 14 is the handheld device according to any one of examples 1 to 13, further including: an end portion extending away from the handle, the end portion including the coupling structure, for example the coupling structure being disposed on a front side of the end portion; for example the coupling structure being disposed on a side of the end portion opposite the handle.

Example 15 is the handheld device according to any one of examples 1 to 14, wherein the coupling structure is configured to couple the interchangeable attachment positively and/or non-positively (e.g., by means of slip-on); and/or wherein the coupling structure is configured to couple the interchangeable attachment magnetically.

Example 16 is the handheld device according to any one of examples 1 to 15 or 52, further including an interface configured to, together with a circuit of the interchanagable attachment, implement a function (for example a process function), wherein the function, for example, is performed with the activity (e.g., as a part thereof), wherein the function, for example: performs a mechanical function (e.g., effects a mechanical influence, e.g. adding material, removing material and/or transforming material), performs a chemical function (e.g. effecting a chemical influence, chemically modifying or transforming), performs an electrodynamic function (e.g. (e.g. having an electrical and/or magnetic function, e.g. effecting an electrodynamic influence), performs a kinematic function (e.g. effecting a kinematic influence), performs a thermodynamic function (e.g. effecting a thermodynamic influence, e.g. extracting and/or supplying thermal energy), and/or performs a radiometric function (e.g. effecting a radiometric influence, e.g., extracting and/or supplying radiant energy), wherein the radiometric function includes, for example, a photometric function (e.g., causing photometric influence, e.g., extracting and/or supplying radiant energy).

Example 17 is the handheld device according to example 16, wherein the interface is configured to provide electrical power to the circuit and/or to communicate with the circuit.

Example 18 is the handheld device according to example 17, wherein the interface is configured to draw electrical energy from a battery of the handheld device.

Example 19 is the handheld device according to any of examples 15 to 18, wherein the interface is configured to communicate with the circuit according to a wireless communication protocol.

Example 20 is the handheld device according to any of examples 1 to 19 or 52, wherein the wireless communication protocol (of the output unit and/or the interface) is set up according to one of NFC (near field communication), RFID (identification using electromagnetic waves), WLAN (wireless local area network), or Bluetooth, for example, wherein the wireless communication protocol of the output unit is Bluetooth, for example, wherein the wireless communication protocol of the interface is NFC.

Example 21 is the handheld device according to any one of examples 15 to 20 or 52, wherein the interface is configured to communicate with the circuit according to a wired communication protocol.

Example 22 is the handheld device according to example 21, wherein according to the wired communication protocol, a carrier frequency technique is implemented.

Example 23 is a system including: a handheld device according to any of examples 1 to 22 or according to example 52; and the device external to the handheld device and/or the interchangeable attachment; wherein, for example, the handheld device according to example 52 includes (e.g., frontally) one or more than one end portion in the form of a tool (e.g., a plurality of mutually interchangeable tools) representing the activity of the machine; the system optionally including: an additional device external to the handheld device including: an additional input unit (e.g., alternatively or in addition to the input unit of the handheld device) configured to input activation information for activating the training of the machine; and an additional output unit (e.g., alternatively or in addition to the input unit of the handheld device) configured to input activation information for activating the training of the machine; the system optionally including: an additional device external to the handheld device including: an additional input unit (e.g., alternative to or in addition to the input unit of the handheld device) configured to input activation information for activating the training of the machine; and an additional output unit (e.g., alternative to or in addition to the output unit of the handheld device) configured to output the activation information for activating the training of the machine (e.g., to the or the additional device external to the handheld device).

Example 24 is the system according to example 23, wherein, for example, the interchangeable attachment has one or more than one end portion in the form of a tool (e.g. a plurality of mutually interchangeable tools) representing the activity of the machine; wherein, for example, the interchangeable attachment has a lighter weight than the hand tool, wherein, for example, the interchangeable attachment has a lower electrical power consumption than the hand tool, wherein, for example, the interchangeable attachment has a smaller size than the hand tool, wherein, for example, the interchangeable attachment includes or is formed from a plastic and/or a light metal, wherein, for example, the tool includes or is formed from a plastic and/or a light metal.

Example 25 is the system according to example 23 or 24, wherein the tool is in the form of: a forming tool representing forming as an activity; a joining tool representing joining as an activity; a displacing tool representing displacing as an activity; an inspecting tool representing optical inspecting as an activity; or a separating tool representing separating as an activity.

Example 26 is the system according to Example 25, wherein the joining tool is a coating tool representing coating as an activity.

Example 27 is the system according to any one of examples 23 to 26, further including: at least one additional interchangeable attachment (for releasably coupling with the coupling structure), wherein the additional interchangeable attachment is configured according to a different activity, which is different from the activity.

Example 28 is the system of example 27, wherein the or each interchangeable attachment and the or each additional interchangeable attachment are configured (e.g., in pairs with respect to each other) such that they may be interchanged with respect to each other, for example, by uncoupling the interchangeable attachment from the coupling structure and coupling the additional interchangeable attachment to the coupling structure.

Example 29 is the system according to any one of examples 23 to 28, wherein the interchangeable attachment or end portion (e.g., of the interchangeable attachment or handheld device) and/or the or each additional interchangeable attachment includes circuitry configured to provide a function.

Example 30 is the system according to example 29, wherein the circuit is configured to provide the function according to the activity.

Example 31 is the system according to example 29 or 30, wherein the circuit includes a sensor implementing the function.

Example 32 is the system according to any of examples 29 to 31, wherein the circuit includes an actuator implementing the function.

Example 33 is the system according to any of examples 29 to 32, wherein the circuit includes a radiation source implementing the function.

Example 34 is the system according to any one of examples 23 to 33, wherein the device external to the handheld device includes a data processing system configured to determine control information for the machine based on the activation information and the activity.

Example 35 is the system according to example 34, wherein the data processing system is configured to take into account a captured mechanical action on the tool, the coupling structure and/or the interchangeable attachment when determining the control information.

Example 36 is the system according to example 34 or 35, wherein the data processing system is configured to take into account a captured and/or ascertained spatial information about: a movement of the handheld device in space, a position of the handheld device in space, and/or an orientation of the handheld device in space when ascertaining the control information.

Example 37 is the system according to any of examples 34 to 36, wherein the data processing system is configured to take into account a captured handling of the handheld device when determining the control information, the handling including, for example, an input at the input unit.

Example 38 is the system according to example 37, wherein the handling includes at least one handling of a function provided by means of the interchangeable attachment or the tool.

Example 39 is the system according to example 38, wherein the handling includes at least one spatial and/or temporal distribution.

Example 40 is the system according to any of examples 34 to 39, wherein the data processing system includes a communication interface that is set up according to a communication protocol of the machine (e.g., its control device).

Example 41 is the system according to example 40, wherein the data processing system is configured to communicate with the machine by means of the communication interface (for example, to transmit the control information or control commands to the machine by means of the communication interface), or wherein the data processing system includes a control device for controlling the machine (and is configured, for example, to receive and/or process the activation information).

Example 42 is the system according to example 40 or 41, further including: an optional attachment device configured to attach the handheld device to the machine, wherein the data processing system is further configured to perform a calibration sequence (e.g., when the handheld device is attached to the machine) by controlling the machine using the communication interface.

Example 43 is the system according to example 42, wherein the calibration sequence includes updating a stored model of the machine, for example based on the captured and/or ascertained spatial information when performing the calibration sequence.

Example 44 is the system according to any one of examples 23 to 43, wherein the device external to the handheld device includes a locating device configured to determine spatial information about: a movement of the handheld device in space, a position of the handheld device in space, and/or an orientation of the handheld device in space control information; and/or configured to emit a (e.g. electromagnetic) locating signal, wherein the locating signal is preferably an optical signal (e.g. an infrared signal) and/or includes a spatial pattern.

Example 45 is the system according to any of examples 23 to 44, wherein the locating device and/or the handheld device is configured to capture a change in position and/or orientation of the handheld device that is smaller than a smallest spatial extent of the handheld device and/or than one millimeter.

Example 46 is the system according to example 43 or 45, wherein the location device includes one or more than one second sensor for capturing the spatial information; and/or wherein the location device includes one or more than one transmitter for transmitting the location signal; and/or wherein the handheld device is configured to determine (e.g., perform a location determination) the spatial information based on the location signal.

Example 47 is the system of example 46, wherein the one or more than one second sensor includes one of: an optoelectronic sensor; an electromagnetic sensor; and/or an acoustic sensor; and/or wherein the one or more than one transmitter includes one of: a laser (e.g., to provide lidar), e.g., an infrared laser, a radio wave transmitter (e.g., to provide radar), and/or an ultrasonic transmitter.

Example 48 is the system of example 47, wherein the optoelectronic sensor includes a camera or lidar sensor; wherein the electromagnetic sensor includes a radar sensor or bearing sensor; wherein the acoustic sensor includes a sonar sensor.

Example 49 is a system for training at least one movement and at least one activity of a machine (e.g., at least its end effector), the system including: a handheld device (e.g., according to any of examples 1 to 21) including a handle and a (e.g., frontal) coupling structure for releasably coupling an interchangeable attachment; the interchangeable attachment (e.g., according to any of examples 1 to 17) configured according to the at least one activity; a data processing system (e.g., according to any of examples 1 to 17) configured to determine control information for the machine based on spatial information about the handheld device and the activity.

Example 50 is a method (e.g., for training at least one movement and at least one activity of a machine), including: capturing spatial information of a handheld device (e.g., the handheld device according to any one of examples 1 to 21) when the activation information has been input (e.g. in response to inputting the activation information); determining control information for the machine based on the spatial information (e.g., optionally a manipulation of the handheld device) and the activity; wherein upon capturing spatial information, manipulation of a handheld device is performed in accordance with the at least one activity, wherein a (e.g., frontal) coupling structure for releasably coupling an interchangeable attachment of the handheld device has the interchangeable attachment coupled thereto, which is configured in accordance with the at least one activity; wherein the control information of the machine is optionally provided to (e.g., stored on) the machine.

Example 51 is a non-volatile storage medium including code segments configured, when executed by a processor, to perform the method of example 50.

Example 52 is a handheld device for training at least one movement and at least one activity of a machine (e.g., at least its end effector), the handheld device including: a handle; an input unit configured to input activation information for activating the training of the machine; an output unit configured to output the activation information for activating the training of the machine to a device external to the handheld device; and a tool (e.g., front-fixed and/or fabric-fixed) configured according to the at least one activity; an optional interface configured to implement a function together with a circuit of the tool or the interchangeable attachment.

Example 53 is a system (e.g., according to any of examples 23 to 49) including: a handheld device (e.g. according to any of examples 1 to 22 or 52) for training at least one movement and at least one activity of a machine, and an attachment device by means of which the handheld device may be detachably coupled to the machine for calibrating the system; the handheld device including, for example: a handle; an input unit configured to input activation information for activating the training of the machine; an output unit configured to output the activation information for activating the training of the machine to a device external to the handheld device; and a tool or coupling structure for detachably coupling an interchangeable attachment, wherein the tool or the interchangeable attachment is configured according to the at least one activity.

Example 54 is any of examples 1 to 49, or 51 to 53, further including (e.g., as part of the handheld device): a control device configured to determine spatial information by means of one or more than one sensor of the handheld device.

1.-25. (canceled)

26. A handheld device for training at least one movement and at least one activity of a machine, the handheld device comprising:
a handle;
an input unit configured to input activation information for activating the training of the machine;
an output unit configured to output the activation information for activating the training of the machine to an external device that is external to the handheld device; and
a coupling structure for releasably coupling an interchangeable attachment configured in accordance with the at least one activity.

27. The handheld device of claim 26, the handheld device further comprising an interface configured to implement a function in conjunction with circuitry of the interchangeable attachment.

28. The handheld device of claim 26, wherein the output unit comprises a wireless communication device for communicating between the handheld device and the external device.

29. The handheld device of claim 26, the handheld device further comprising a battery.

30. The handheld device of claim 26, wherein the input unit is configured to capture a handling of the handheld device while performing the activity.

31. The handheld device of claim 26, the handheld device further comprising a feedback unit configured to generate feedback to a user of the handheld device.

32. The handheld device of claim 26, the handheld device further comprising a sensor configured to capture an electromagnetic location signal.

33. The handheld device of claim 31, wherein the sensor comprises an optoelectronic sensor configured to capture the location signal.

34. The handheld device of claim 26, the handheld device further comprising an additional sensor configured to capture spatial information about at least one of a movement of the handheld device in space, a position of the handheld device in space, and an orientation of the handheld device in space.

35. The handheld device of claim 34, wherein the additional first sensor comprises a motion sensor or a position sensor.

36. The handheld device of claim 26, wherein the coupling structure is configured to positively couple the interchangeable attachment.

37. The handheld device of claim 27, wherein the interface is configured to provide electrical power to the circuit or to communicate with the circuit.

38. The handheld device of claim 26, wherein the coupling structure is arranged on the front side of the handheld device.

39. The handheld device of claim 26, wherein the interchangeable attachment comprises an end portion of a tool that represents the activity of the machine.

40. The handheld device of claim 26, the handheld device further comprising an additional interchangeable attachment, wherein the additional interchangeable attachment is configured according to another activity of the machine that is different from the activity of the machine, and wherein the additional interchangeable attachment and the interchangeable attachment are configured to be interchangeable with each other.

41. The handheld device of claim 26, wherein the interchangeable attachment comprises circuitry configured to provide a function.

42. A handheld device for training a movement and an activity of a machine, the handheld device comprising:
a handle;
an input unit configured to input activation information for activating the training of the machine;
an output unit configured to output the activation information for activating the training of the machine to a device external to the handheld device; and
a tool configured according to the at least one activity.

43. The handheld device of claim 42, the handheld device further comprising an interface configured to, together with a circuit of the tool, implement the function.

44. A system for training a movement and an activity of a machine, the system comprising:
a handheld device comprising:
a handle; and
a coupling structure for releasably coupling an interchangeably attachable tool, wherein the interchangeably attachable tool is configured to perform the activity; and
an external device that is external to the handheld device, the external device comprising:
an input unit configured to input activation information for activating the movement for training the machine; and
an output unit configured to output the activation information activating the movement for training the machine.

45. The system of claim 44, wherein the handheld device further comprises an interface configured to implement a function together with a circuit of the interchangeably attachable tool.
